(19) United States
(12) Patent Application Publication
(10) Pub. No.: US 2026/0073853 A1
(43) Pub. Date: Mar. 12, 2026

(54) DISPLAY PANEL, DRIVING METHOD, AND DISPLAY DEVICE

(71) Applicant: Xiamen Tianma Display Technology Co., Ltd., Xiamen (CN)

(72) Inventors: Weixing LIU, Xiamen (CN); Yu ZHENG, Xiamen (CN)

(73) Assignee: Xiamen Tianma Display Technology Co., Ltd., Xiamen (CN)

(21) Appl. No.: 19/390,963

(22) Filed: Nov. 17, 2025

(30) Foreign Application Priority Data
Jul. 4, 2025 (CN) 202510925762.0

(51) Int. Cl. G09G 3/32

(52) U.S. Cl. CPC G09G 3/32; G09G 2300/043; G09G 2300/0819; G09G 2310/0245; G09G 2310/0286; G09G 2320/0233; G09G 2320/0247; G09G 2330/021

(57) ABSTRACT

Provided are a display panel, a driving method, and a display device. The refresh rate of the first display area is not equal to the refresh rate of the second display area. In the first display area and/or the second display area, a pixel circuit satisfying the following exists: The active pulse phase of the threshold compensation control signal and the active pulse phase of the gate reset control signal at least partially overlap. The overlap time between the active pulse phase of the threshold compensation control signal and the active pulse phase of the gate reset control signal in the pixel circuit of the first display area is not equal to the overlap time between the active pulse phase of the threshold compensation control signal and the active pulse phase of the gate reset control signal in the pixel circuit of the second display area.

### CROSS-REFERENCE TO RELATED APPLICATION

This application claims priority to Chinese Patent Application No. 202510925762.0 filed Jul. 4, 2025, the disclosure of which is incorporated herein by reference in its entirety.

### TECHNICAL FIELD

Embodiments of the present disclosure relate to the field of display technology, and in particular, to a display panel, a driving method, and a display device.

### BACKGROUND

With the development of display technology, various new types of display panels have emerged, bringing great convenience to people's daily life and work and gaining widespread favor among consumers.

For different application scenarios, current display panels have been developed with a partitioned frequency division function. Specifically, for certain application scenarios, a display screen is divided into several partitions, and each partition has an independent refresh rate, thereby reducing the driving power consumption of the display panel. However, during such dynamic partitioned frequency division display, due to different refresh rates in different partitions, issues such as varying brightness across different partitions and flicker during dynamic refresh occur, leading to uneven display and affecting the display effect.

### SUMMARY

The present disclosure provides a display panel, a driving method, and a display device to improve the brightness difference of the first frame in each display area, balance the display brightness across display areas, avoid flicker, and enhance the display effect.

In a first aspect, embodiments of the present disclosure provide a display panel. The display panel includes multiple pixel units, and a pixel unit includes a pixel circuit and a light-emitting element.

The pixel circuit includes a drive circuit, a gate reset circuit, and a threshold compensation circuit. The drive circuit includes a drive transistor. The drive transistor includes a gate and a first electrode. The gate reset circuit is coupled to the gate. The light-emitting element is coupled to the first electrode. The threshold compensation circuit is separately coupled to the gate and the first electrode of the drive transistor.

The gate reset circuit of the pixel circuit is configured to write a gate reset signal to the gate of the drive transistor during an active pulse phase of a gate reset control signal, and the threshold compensation circuit of the pixel circuit is configured to connect the gate and the first electrode during an active pulse phase of a threshold compensation control signal.

The display panel at least includes a first display area and a second display area. The first display area and the second display area do not overlap. f1 denotes the refresh rate of the first display area, and f2 denotes the refresh rate of the second display area, where f1≠f2.

In the first display area and/or the second display area, a pixel circuit satisfying the following: the active pulse phase of the threshold compensation control signal and the active pulse phase of the gate reset control signal being at least partially overlapped.

In the pixel circuit of the first display area, T1 denotes the overlap time between the active pulse phase of the threshold compensation control signal and the active pulse phase of the gate reset control signal, and in the pixel circuit of the second display area, T2 denotes the overlap time between the active pulse phase of the threshold compensation control signal and the active pulse phase of the gate reset control signal, where T1≠T2.

In a second aspect, embodiments of the present disclosure also provide a driving method for a display panel. The display panel includes multiple pixel units, and a pixel unit includes a pixel circuit and a light-emitting element.

The pixel circuit includes a drive circuit, a gate reset circuit, and a threshold compensation circuit. The drive circuit includes a drive transistor. The drive transistor includes a gate and a first electrode. The gate reset circuit is coupled to the gate. The light-emitting element is coupled to the first electrode. The threshold compensation circuit is separately coupled to the gate and the first electrode of the drive transistor.

The driving method includes causing the gate reset circuit to write a gate reset signal to the gate of the drive transistor during an active pulse phase of a gate reset control signal, and causing the threshold compensation circuit to connect the gate and the first electrode during an active pulse phase of a threshold compensation control signal.

The display panel includes a first display area and a second display area. The first display area and the second display area do not overlap. f1 denotes the refresh rate of the first display area is f1, and f2 denotes the refresh rate of the second display area, where f1≠f2.

In the first display area and/or the second display area, a pixel circuit satisfying the following exists: The active pulse phase of the threshold compensation control signal and the active pulse phase of the gate reset control signal at least partially overlap.

In the pixel circuit of the first display area, T1 denotes the overlap time between the active pulse phase of the threshold compensation control signal and the active pulse phase of the gate reset control signal. In the pixel circuit of the second display area, T2 denotes the overlap time between the active pulse phase of the threshold compensation control signal and the active pulse phase of the gate reset control signal.

In a third aspect, embodiments of the present disclosure also provide a display device including the display panel as described in the first aspect.

### BRIEF DESCRIPTION OF DRAWINGS

FIG. 1 is a schematic diagram illustrating the structure of a display panel in related art.

FIG. 2 is a schematic diagram illustrating the structure of a pixel circuit in the display panel shown in FIG. 1.

FIG. 3 is a schematic diagram of brightness variations in different partitions of the display panel shown in FIG. 1.

FIG. 4 is a schematic diagram illustrating the structure of a display panel according to an embodiment of the present disclosure.

FIG. 5 is a schematic diagram illustrating the structure of a pixel circuit in the display panel shown in FIG. 4.

FIG. 6 is a drive timing graph of the pixel circuit shown in FIG. 5.

FIG. 7 is a schematic diagram of refresh rates of different partitions of the display panel shown in FIG. 4.

FIG. 8 is a drive timing graph of pixel circuits in different display areas of the display panel shown in FIG. 4.

FIG. 9 is another drive timing graph of pixel circuits in different display areas of the display panel shown in FIG. 4.

FIG. 10 is a driving timing graph of different partitions of the display panel shown in FIG. 4.

FIG. 11 to FIG. 14 are another four driving timing graphs of pixel circuits in different display areas of the display panel shown in FIG. 4.

FIG. 15 is a schematic diagram illustrating the structure of a first shift register circuit of the display panel shown in FIG. 4.

FIG. 16 is another driving timing graph of the display panel shown in FIG. 4.

FIG. 17 is a schematic diagram illustrating the structure of another first shift register circuit of the display panel shown in FIG. 4.

FIG. 18 is another driving timing graph of the display panel shown in FIG. 4.

FIG. 19 is a schematic diagram illustrating the structure of another first shift register circuit of the display panel shown in FIG. 4.

FIG. 20 is another driving timing graph of the display panel shown in FIG. 4.

FIG. 21 is a schematic diagram illustrating the structure of another pixel circuit according to an embodiment of the present disclosure.

FIG. 22 is a drive timing graph of the pixel circuit shown in FIG. 21.

FIG. 23 is a flowchart of a driving method of a display panel according to an embodiment of the present disclosure.

FIG. 24 is a schematic diagram illustrating the structure of a display device according to an embodiment of the present disclosure.

### DETAILED DESCRIPTION

Hereinafter the present disclosure is further described in detail in conjunction with the drawings and embodiments. It is to be understood that the embodiments described herein are only intended to illustrate but not to limit the present disclosure. Additionally, it is to be noted that for ease of description, only part, not all, of structures related to the present disclosure are illustrated in the drawings.

Terms used in the embodiments of the present disclosure are intended only to describe the embodiments and not to limit the present disclosure. It is to be noted that nouns of locality such as “on”, “below”, “left”, and “right” in the embodiments of the present disclosure are described from angles shown in the drawings and are not to be construed as limiting the embodiments of the present disclosure. Additionally, in the context, it is to be understood that when an element is formed “on” or “below” another element, the element can not only be directly formed “on” or “below” the other element but also be indirectly formed “on” or “below” the other element via an intermediate element. Terms such as “first” and “second” are used only for the purpose of description to distinguish between different components and not to indicate any order, quantity, or importance. For those of ordinary skill in the art, specific meanings of the preceding terms in the present disclosure can be understood based on specific situations.

As used herein, the term “include” and variations thereof are intended to be inclusive, that is, “including, but not limited to”. The term “based on” is “at least partially based on”. The term “an embodiment”indicates “at least one embodiment”.

It is to be noted that concepts such as “first” and “second” in the present disclosure are used to distinguish between corresponding content and are not intended to limit the order or mutual dependence.

It is to be noted that “one” and “multiple” mentioned in the present disclosure are not limiting but illustrative and should be construed by those skilled in the art as “at least one” unless otherwise specified in the context.

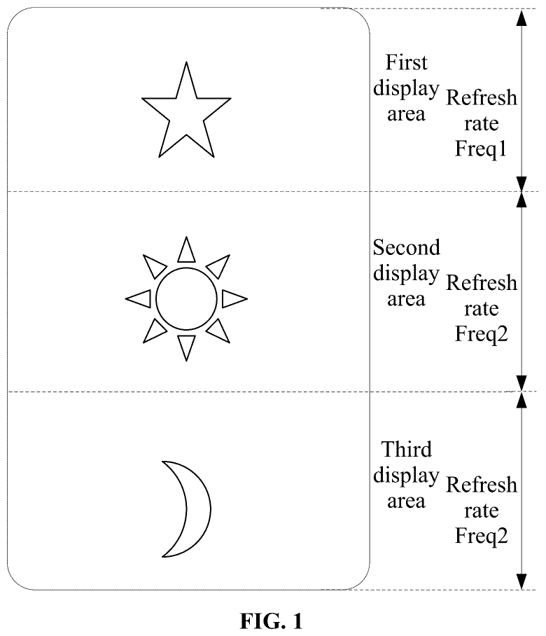

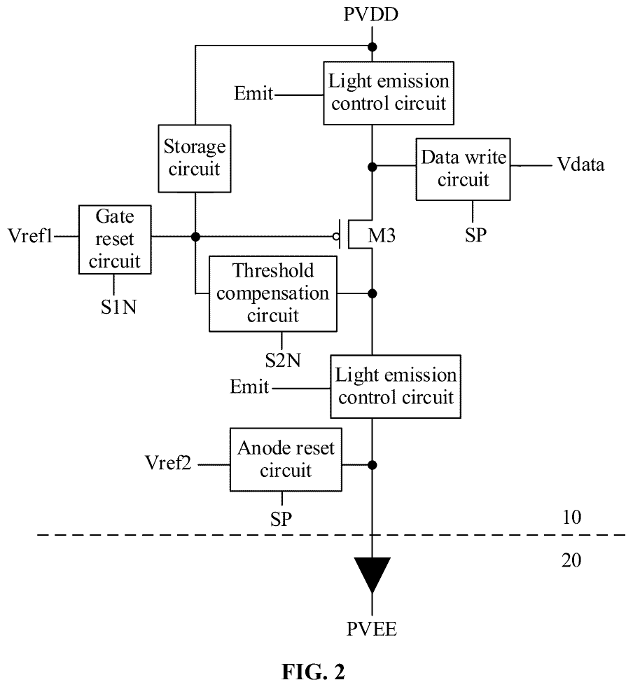

FIG. 1 is a schematic diagram illustrating the structure of a display panel in related art. FIG. 2 is a schematic diagram illustrating the structure of a pixel circuit in the display panel shown in FIG. 1. FIG. 3 is a schematic diagram of brightness variations in different partitions of the display panel shown in FIG. 1. With reference to FIG. 1 to FIG. 3, based on the display requirements of certain application scenarios, the display area in a related display panel may be divided, as shown in the example, into three display areas. Different display areas may adopt different refresh rates for display. For example, a high refresh rate may be used in a certain display area to meet the smoothness requirements of the display area, and a low refresh rate may be used in another display area to reduce the power consumption of the entire display panel. As shown in FIG. 1, different refresh rates may be set in the three display areas according to the needs of each display area, that is, a partitioned frequency division display mode is adopted.

Specifically, with reference to FIG. 2, those skilled in the art can understand that the display panel includes multiple pixel units arranged in an array. The pixel unit includes a pixel circuit 10 and a light-emitting element 20. The pixel circuit 10 is used to drive the light-emitting element 20 to emit light. Through the driving of the pixel circuit 10, each light-emitting element 20 in the display panel emits light with a specific color and brightness in each display frame, thereby presenting a display image macroscopically. In each display frame where the pixel circuit 10 drives the light-emitting element 20 to emit light, the drive transistor M3 in the pixel circuit 10 is responsible for controlling the drive current of the light-emitting element 20, thereby adjusting the brightness of the light-emitting element 20 in the current display frame. Further, the refresh rate of a display panel or display area refers to the number of times the display image of the display panel or display area is refreshed within a unit time period. To achieve different refresh rates for the display panel or display area, a refresh frame Trefresh and a hold frame Thold may be set. In the refresh frame Trefresh, the brightness of the light-emitting element 20 is refreshed to ensure that the current display panel or display area presents a new image in the display frame, while in the hold frame Thold, the brightness of the light-emitting element 20 from the previous refresh frame Trefresh only needs to be maintained, that is, the display panel or display area maintains the previously updated display image in the display frame. Thus, by the configuration of different numbers of refresh frames Trefresh within a unit time period, different numbers of display image updates can be achieved, and the adjustment of the refresh rate can be achieved.

With continued reference to FIG. 2, however, during the process of controlling the generation of the drive current by the drive transistor M3, the drive transistor M3 is in a forward bias state. With the passage of time, the electrical characteristic curve of the drive transistor M3 in the forward bias state drifts, and the threshold voltage gradually increases. As shown in FIG. 3, when a refresh frame Trefresh is followed by multiple hold frames Thold in an image refresh cycle T to reduce the refresh rate of the display area, since the brightness of the light-emitting element 20 does not need to be updated in the hold frame Thold and no reset operation is performed on the drive transistor M3, the drive transistor M3 remains in a forward bias state throughout the image refresh cycle T. As a result, the electrical characteristic curve of the drive transistor M3 continues to drift, and the threshold voltage becomes increasingly larger, resulting in the final actual brightness of the light-emitting element 20 being higher than the target brightness, and the brightness in the image refresh cycle T shows a gradually increasing trend. Moreover, during the image switching process, the drive transistor M3 exhibits a hysteresis effect, leading to a lower brightness in the first frame, that is, the refresh frame Trefresh, of the image refresh cycle T, and the hysteresis effect gradually weakens over time in the image refresh cycle T, causing the brightness of subsequent display frames to gradually recover, thus further exacerbating the trend of increasing brightness of the light-emitting element 20 within the image refresh cycle T. As can be seen, due to different refresh rates in each display area, the duration of the image refresh cycle varies, and the degree of drift in the electrical characteristic curve of the drive transistor M3 differs, resulting in different differences between the final actual brightness and the first frame brightness of the light-emitting element 20. As shown in the example in FIG. 3, the brightness ratios of the first frame display brightness to the final stable display brightness in different display areas are 70%, 65%, and 60%, respectively, causing users to perceive unsynchronized brightness variations across different display areas, uneven display, and flicker during dynamic refresh.

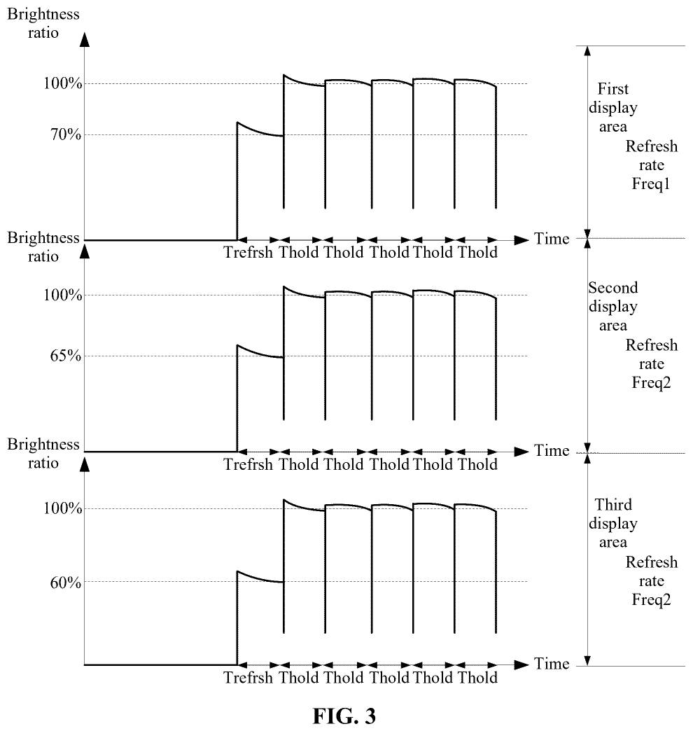

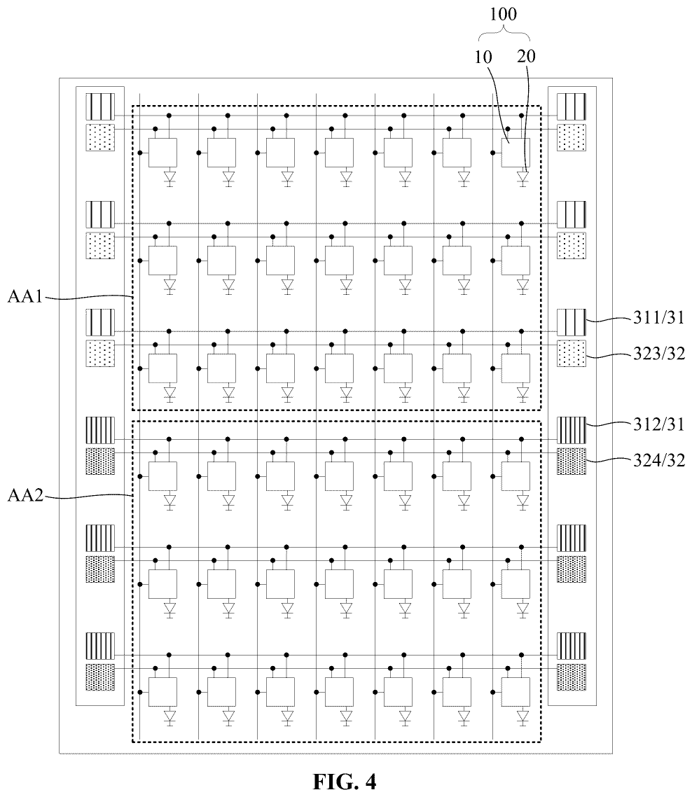

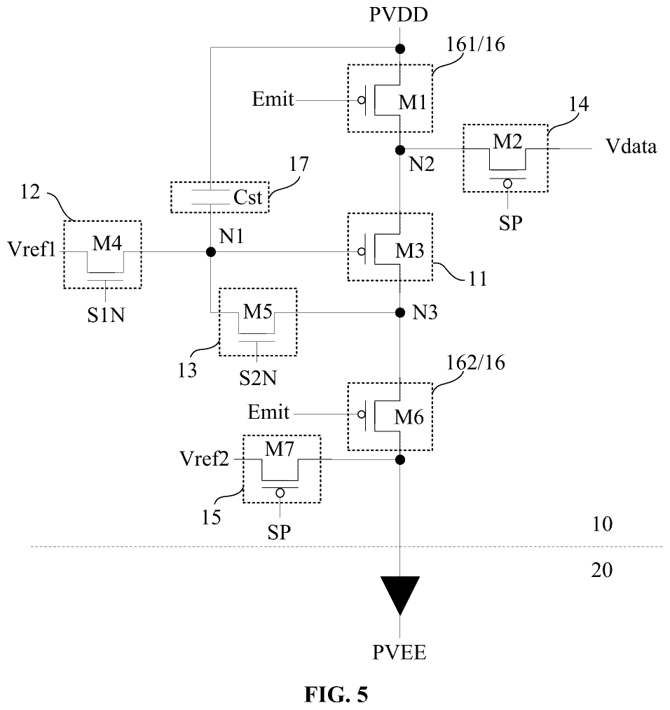

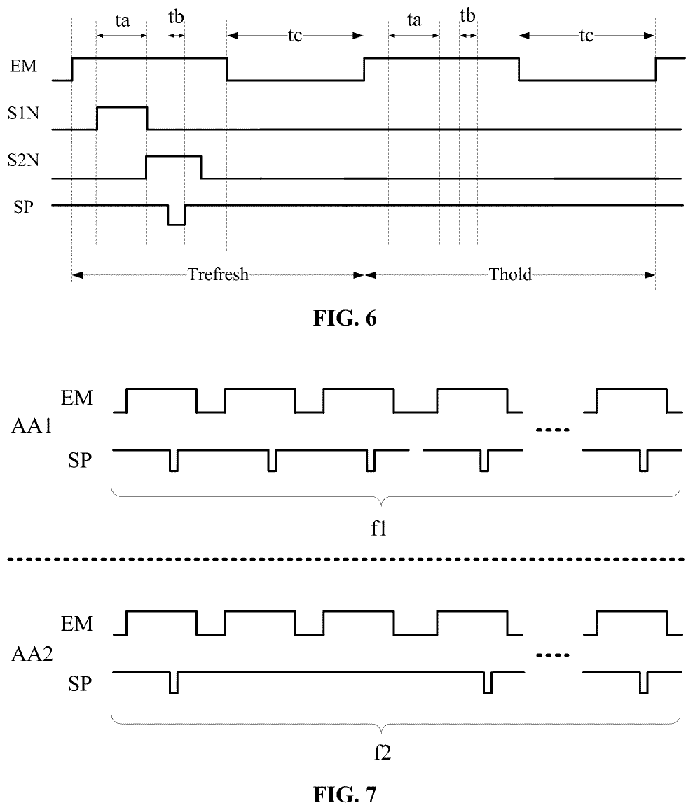

To address the preceding issues, the embodiments of the present disclosure provide a display panel. FIG. 4 is a schematic diagram illustrating the structure of a display panel according to an embodiment of the present disclosure. FIG. 5 is a schematic diagram illustrating the structure of a pixel circuit in the display panel shown in FIG. 4. FIG. 6 is a drive timing graph of the pixel circuit shown in FIG. 5. First, with reference to FIG. 4, the display panel provided by this embodiment of the present disclosure may include multiple pixel units 100, and the pixel unit 100 includes a pixel circuit 10 and a light-emitting element 20. The pixel circuit 10 is used to drive the light-emitting element 20 to emit light. The pixel units 100, as shown in FIG. 4, may be arranged in an array. At the microscopic level, each pixel circuit 10 drives a corresponding light-emitting element 20 to light up, which can present a display image macroscopically.

With reference to FIG. 4 and FIG. 5, specifically, the pixel circuit 10 includes a drive circuit 11, a gate reset circuit 12, and a threshold compensation circuit 13. The drive circuit 11 includes a drive transistor M3, and the drive transistor M3 includes a gate and a first electrode. The gate reset circuit 12 is coupled to the gate. The light-emitting element 20 is coupled to the first electrode. The threshold compensation circuit 13 is separately coupled to the gate and the first electrode of the drive transistor M3. The gate reset circuit 12 includes a gate reset transistor M4. The gate of the gate reset transistor M4 receives a gate reset control signal S1N, one electrode receives a gate reset signal Vref1, and the other electrode is connected to the gate of the drive transistor M3. The threshold compensation circuit 13 includes a threshold compensation transistor M5. The gate of the threshold compensation transistor M5 receives a threshold compensation control signal S2N, and two electrodes of the threshold compensation transistor M5 are respectively connected to the gate and the first electrode, that is, the third node N3, of the drive transistor M3. In addition to the preceding circuits, the pixel circuit 10 may optionally include a data write circuit 14, an anode reset circuit 15, a light emission control circuit 16, and a storage circuit 17. The light emission control circuit 16 may include a first light emission control unit 161 and a second light emission control unit 162. The data write circuit 14 includes a data write transistor M2. The anode reset circuit 15 includes an anode reset transistor M7. The first light emission control unit 161 includes a first light emission control transistor M1. The second light emission control unit 162 includes a second light emission control transistor M6. The storage circuit 17 includes a storage capacitor Cst. The connection methods and corresponding control signals of the preceding circuits or transistors are as shown in FIG. 5 and are not repeated here. It should be noted that in the embodiments of the present disclosure, the gate reset transistor M4 and the threshold compensation transistor M5 adopt N-type channel transistors, while the other transistors adopt P-type channel transistors, which is only an example of the present disclosure. Those skilled in the art may make selections and arrangements as needed, and no limitation is imposed here.

The gate reset circuit 12 of the pixel circuit 10 is configured to write the gate reset signal Vref1 to the gate of the drive transistor M3 in an active pulse phase of the gate reset control signal S1N, and the threshold compensation circuit 13 of the pixel circuit 10 is configured to connect the gate and the first electrode in an active pulse phase of the threshold compensation control signal S2N. The driving process of the pixel circuit 10 may include a gate reset phase ta, a data write phase tb, and a light emission phase tc. In the gate reset phase ta, the gate reset signal Vref1 is written to the gate of the drive transistor M3 to reset the drive transistor M3, ensuring that the data signal Vdata subsequently written to the gate of the drive transistor M3 is not affected by the data signal Vdata written or stored in a previous display frame. The threshold compensation circuit 13 is used to add a threshold voltage of the drive transistor M3 into the data signal Vdata during the data write phase tb when the data signal Vdata is written to the gate of the drive transistor M3, ensuring that the drive current generated by the drive transistor M3 based on the data signal Vdata stored at the gate during the light emission phase tc is affected by the threshold voltage of the drive transistor M3, thus achieving threshold compensation.

With reference to FIG. 6, the specific driving process and principle of the pixel circuit exemplified in FIG. 5 are introduced below. First, the driving process of the pixel circuit may be divided into a refresh frame Trefresh and a hold frame Thold.

The refresh frame Trefresh may include a gate reset phase ta, a data write phase tb, and a light emission phase tc. In the gate reset phase ta, the gate reset control signal S1N received by the gate of the gate reset transistor M4 in the gate reset circuit 12 is at a logic high level and is an active pulse signal. The gate reset circuit 12 is turned on, and the gate reset signal Vref1 is input to a first node N1, that is, the gate of the drive transistor M3, to reset the gate of the drive transistor M3. In the data write phase tb, the data write control signal SP received by the gate of the data write transistor M2 in the data write circuit 14 is at a logic low level and is an active pulse signal, and the data write circuit 14 is turned on. Meanwhile, the threshold compensation control signal S2N received by the gate of the threshold compensation transistor M5 in the threshold compensation circuit 13 is at a logic high level and is an active pulse signal, and the threshold compensation circuit 13 is turned on. The data signal Vdata is input to the first node N1 through the data write circuit 14, the drive circuit 11, and the threshold compensation circuit 13 and is stored by the storage circuit 17. In the light emission phase tc, the light emission control signal Emit received by the gates of both the first light emission control transistor M1 in the first light emission control unit 161 and the second light emission control transistor M6 in the second light emission control unit 162 is at a logic low level and is an active pulse, and the first light emission control unit 161 and the second light emission control unit 162 are turned on. The drive transistor M3 provides a corresponding drive current to the light-emitting element 20 based on the data signal Vdata stored at the gate, causing the light-emitting element 20 to emit light at a target brightness. Additionally, the gate of the anode reset transistor M7 in the anode reset circuit 15 also receives the data write control signal SP. In the data write phase tb, the anode reset circuit 15 is synchronously controlled to be turned on by the data write control signal SP and writes an anode reset signal Vref2 to the anode of the light-emitting element 20, thereby ensuring that no residual charge from the previous display frame exists at the anode of light-emitting element 20 and affects the brightness of the current display frame before the light emission phase tc.

The hold frame Thold only includes a light emission phase tc, and the hold frame Thold is set after the refresh frame Trefresh. After the data voltage is written and stored in the data write phase tb of the refresh frame Trefresh, the stored data voltage may continue to drive the light-emitting element 20 while the display image remains unchanged. Thus, in the light emission phase tc of the hold frame Thold, the light emission control signal Emit is an active pulse, the first light emission control unit 161 and the second light emission control unit 162 are turned on, and the drive transistor M3 provides a corresponding drive current to the light-emitting element 20 based on the data signal Vdata stored at the gate, causing the light-emitting element 20 to emit light at a target brightness.

From the above, it can be understood that within the same image refresh cycle T, the refresh frame Trefresh and the hold frame Thold share only the same light emission control signal Emit. Moreover, the current display frame is determined to be a refresh frame Trefresh based on the active pulse of the data write signal, and the refresh rate of the display image can be determined based on the proportion of the display frames with active pulses of the data write signal.

FIG. 7 is a schematic diagram of refresh rates of different partitions of the display panel shown in FIG. 4. With continued reference to FIG. 4 to FIG. 7, further, the display panel at least includes a first display area AA1 and a second display area AA2, and the first display area AA1 and the second display area AA2 do not overlap. f1 denotes the refresh rate of the first display area AA1, and f2 denotes the refresh rate of the second display area AA2, where f1≠f2. The pixel circuits 10 in the first display area AA1 and the second display area AA2 are configured with data write control signals SP having different pulse frequencies. f1 denotes the pulse frequency of the data write control signal SP for the pixel circuit 10 in the first display area AA1 is f1, and the pulse frequency of the data write control signal SP for the pixel circuit 10 in the second display area AA2 is f2. Thus, the refresh rate for the first display area AA1 is f1, and the refresh rate for the second display area AA2 is f2.

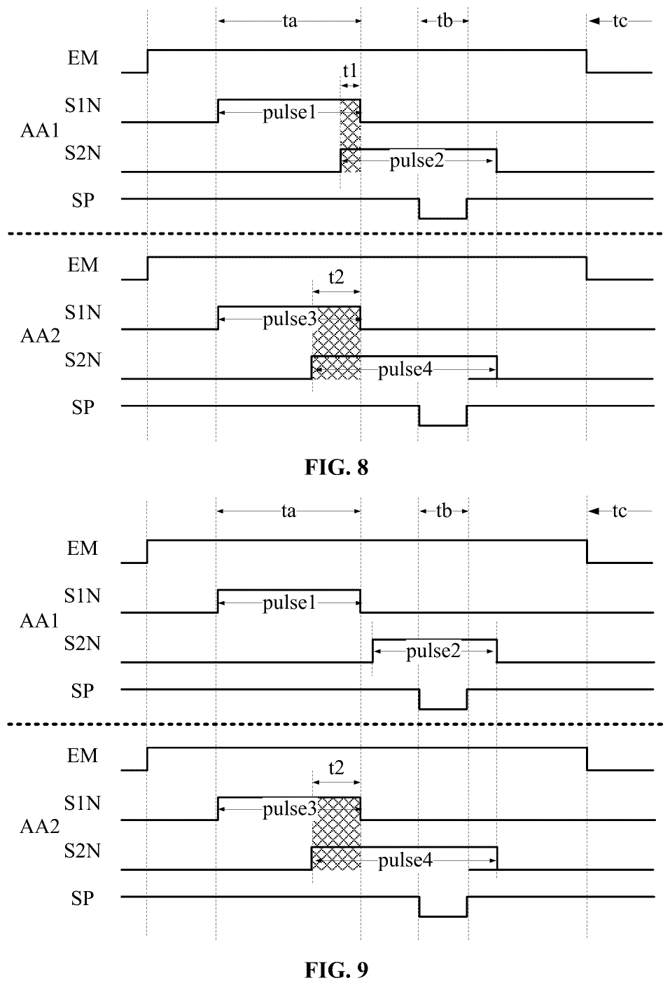

FIG. 8 is a drive timing graph of pixel circuits in different display areas of the display panel shown in FIG. 4. With reference to FIG. 8, further, in the first display area AA1 and/or the second display area AA2, a pixel circuit 10 satisfying the following exists: The active pulse phase of the threshold compensation control signal S2N and the active pulse phase of the gate reset control signal S1N at least partially overlap.

In the technical solution of the embodiments of the present disclosure, the active pulse phase of the threshold compensation control signal S2N and the active pulse phase of the gate reset control signal S1N are configured to overlap. The purpose is that during the gate reset process, namely, during the process of writing a gate reset signal Vref1 to the gate of the drive transistor M3, the threshold compensation circuit 13 can be turned on to synchronously write the gate reset signal Vref1 to the first electrode, that is, a third node N3, of the drive transistor M3. The gate reset signal Vref1 is written so that the potential of the third node N3 can be negatively biased, increasing the voltage difference across the drive transistor M3 and facilitating the writing of a data signal Vdata in the data write phase tb. Meanwhile, the reverse bias of the third node N3 potential can adjust an anode potential of the light-emitting element 20 to a reverse bias, which also facilitates the activation of the light-emitting element 20. As a result, the brightness of the light-emitting element 20 can be enhanced to a certain extent.

It should be noted that the limitation that the active pulse phase of the threshold compensation control signal S2N and the active pulse phase of the gate reset control signal S1N at least partially overlap may apply to the pixel circuit 10 in the first display area AA1, the pixel circuit 10 in the second display area AA2, or both the pixel circuits 10 in the first display area AA1 and the second display area AA2. FIG. 9 is another drive timing graph of pixel circuits in different display areas of the display panel shown in FIG. 4. Comparing FIG. 8 and FIG. 9, in another embodiment of the present disclosure, it can be set that the active pulse phase of the threshold compensation control signal S2N and the active pulse phase of the gate reset control signal S1N in one display area (such as the first display area AA1 as shown in the example) do not overlap.

With continued reference to FIG. 8, further, in the pixel circuit 10 of the first display area AA1, T1 denotes the overlap time between the active pulse phase of the threshold compensation control signal S2N and the active pulse phase of the gate reset control signal S1N, and in the pixel circuit 10 of the second display area AA2, T2 denotes the overlap time between the active pulse phase of the threshold compensation control signal S2N and the active pulse phase of the gate reset control signal S1N, where T1≠T2.

As described earlier, due to different refresh rates in different display areas, where the refresh rate of the first display area AA1 is f1 and the refresh rate of the second display area AA2 is f2, a difference exists in the brightness ratio of the first frame display brightness to the final stable display brightness in the two display areas, causing unsynchronized brightness variations, uneven display, and flicker during dynamic refresh. In the embodiments of the present disclosure, the overlap time T1 between the active pulse phase of the threshold compensation control signal S2N and the active pulse phase of the gate reset control signal S1N in the first display area AA1 is not equal to the overlap time T2 between the active pulse phase of the threshold compensation control signal S2N and the active pulse phase of the gate reset control signal S1N in the second display area AA2. In this manner, it is possible to set different overlap times according to the difference in the brightness ratio of the first frame display brightness to the final stable display brightness caused by the refresh rates of the first display area AA1 and the second display area AA2. Thus, when the gate reset signal Vref1 is written to the first electrode, that is, the third node N3, of the respective drive transistors M3, respective reverse bias effects of corresponding potentials can be achieved, thereby enhancing the brightness of the respective light-emitting elements 20 in the refresh frame Trefresh, improving the first frame display brightness, balancing the brightness ratio of the first frame brightness to the final stable display brightness across display areas, and ensuring synchronized brightness variations across display areas, uniform display brightness, and smooth dynamic refresh.

With continued reference to FIG. 9, in another embodiment of the present disclosure, it can be set that the active pulse phase of the threshold compensation control signal S2N and the active pulse phase of the gate reset control signal S1N in one display area (such as the first display area AA1 as shown in the example) do not overlap, that is, the overlap time T1 is 0, while the overlap time T2 between the active pulse phase of the threshold compensation control signal S2N and the active pulse phase of the gate reset control signal S1N in another display area (such as the second display area AA2 as shown in the example) is not 0. In this case, the preceding active pulses in one display area are changed to overlap so that during the operation of the display area, when the gate reset signal Vref1 is written to the first electrode, that is, the third node N3, of the drive transistor M3, a reverse bias effect on the first electrode of the drive transistor M3 can be achieved, thereby enhancing the brightness of the light-emitting element 20 in the refresh frame Trefresh, improving the first frame display brightness, balancing the brightness ratio of the first frame brightness to the final stable display brightness between this display area and other display areas, and ensuring synchronized brightness variations across display areas, uniform display brightness, and smooth dynamic refresh.

Specifically, in the embodiments of the present disclosure, it can be set that f1>f2, and 0≤T1<T2.

When the refresh rate f1 of the first display area AA1 is higher than the refresh rate f2 of the second display area AA2, it means that the image refresh cycle in the first display area AA1 is relatively short, and the image refresh cycle in the second display area AA2 is relatively long. As mentioned earlier, in the second display area AA2 with a relatively long image refresh cycle, the degree of drift in the electrical characteristic curve of the drive transistor is greater, and the threshold voltage is larger, resulting in a higher final stable display brightness in the current image refresh cycle T. In other words, the brightness ratio of the first frame display brightness to the final stable display brightness in the second display area AA2 is smaller compared to that in the first display area AA1. Therefore, the overlap time T2 between the active pulse phase of the threshold compensation control signal S2N and the active pulse phase of the gate reset control signal S1N in the second display area AA2 is relatively large so that the brightness of the light-emitting element 20 in the second display area AA2 in the refresh frame Trefresh, that is, the first frame, can be enhanced to some extent, thereby improving the first frame display brightness and increasing the brightness ratio of the first frame display brightness to the final stable display brightness. This arrangement can achieve the same or similar brightness ratio of the first frame display brightness to the final stable display brightness as the first display area AA1, ensuring synchronized brightness variations across the two display areas, uniform display, and smooth dynamic refresh.

Specifically, in the embodiments of the present disclosure, it can be optionally set that |f1−f2|>Δf, where Δf is a preset frequency difference.

A preset frequency difference, such as 5 Hz, 10 Hz, 20 Hz, or 30 Hz is preset. Different overlap times are set for the two display areas only when the refresh rate difference between the two display areas is greater than the preset frequency difference. In this manner, the driving timing is adjusted only for the two display areas with a relatively large refresh rate difference, a relatively large difference in the brightness ratio of the first frame display brightness to the final stable display brightness, and a relatively noticeable brightness difference, while cases where the refresh rate difference is relatively small, the difference in the brightness ratio of the first frame display brightness to the final stable display brightness is relatively small, and no noticeable brightness difference is perceived are ignored. Thus, the complexity of the driving process of the display panel is simplified, thereby adapting to the actual needs of the display panel.

Specifically, in the embodiments of the present disclosure, the display driving process of the display panel includes multiple image refresh cycles T, and the image refresh cycle T includes at least one refresh frame Trefresh. In the image refresh cycle T of the first display area AA1, P1 denotes the duration proportion of the refresh frame Trefresh in the image refresh cycle T, and in the image refresh cycle T of the second display area AA2, P2 denotes the duration proportion of the refresh frame Trefresh in the image refresh cycle T. Based on this, it can be set that P1>P2, and 0≤T1<T2.

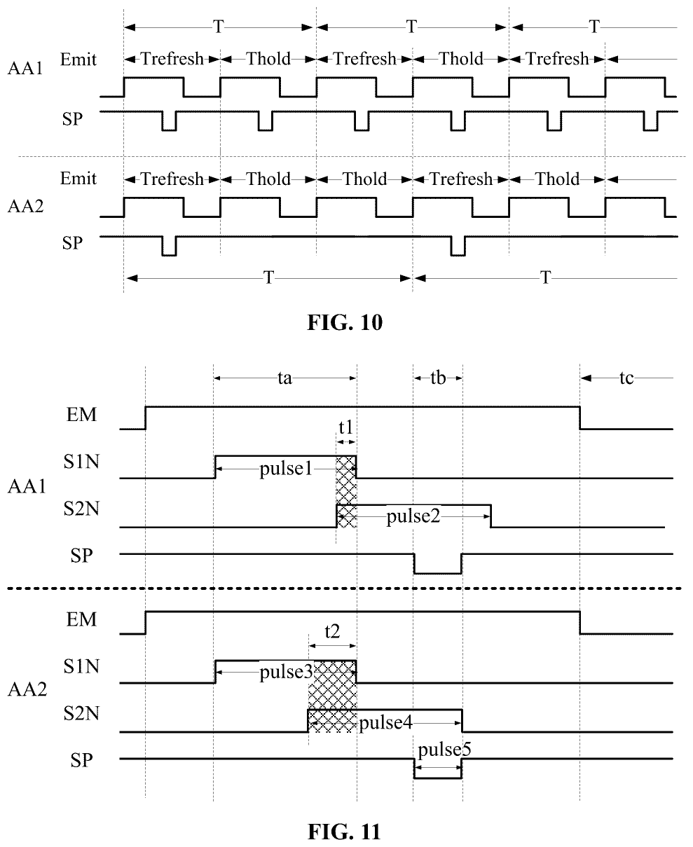

FIG. 10 is a driving timing graph of different partitions of the display panel shown in FIG. 4. With reference to FIG. 4, FIG. 5, and FIG. 10, different display areas of the display panel can be driven and displayed in partitions, forming different refresh frames Trefresh and hold frames Thold. Exemplarily, an image refresh cycle T of the first display area AA1 may include one refresh frame Trefresh and one hold frame Thold, while an image refresh cycle T of the second display area AA2 may include one refresh frame Trefresh and two hold frames Thold. Thus, in the first display area AA1, the duration proportion of the refresh frame Trefresh in the image refresh cycle T is ½, while in the second display area AA2, the duration proportion of the refresh frame Trefresh in the image refresh cycle T is ⅓. Since the duration proportion of the refresh frame Trefresh in the second display area AA2 is smaller, the duration of the image refresh cycle T is longer, the degree of drift in the electrical characteristic curve of the drive transistor is greater, and the threshold voltage is larger, resulting in a higher final stable display brightness in the current image refresh cycle T. In other words, the brightness ratio of the first frame display brightness to the final stable display brightness in the second display area AA2 is relatively small compared to that in the first display area AA1. Based on this, with reference to FIG. 8 and FIG. 9, the overlap time T2 between the active pulse phase of the threshold compensation control signal S2N and the active pulse phase of the gate reset control signal S1N in the second display area AA2 is relatively large so that the brightness of the light-emitting element 20 in the second display area AA2 in the refresh frame Trefresh, that is, the first frame, can be enhanced to some extent, thereby improving the first frame display brightness and increasing the brightness ratio of the first frame display brightness to the final stable display brightness. This arrangement can achieve the same or similar brightness ratio of the first frame display brightness to the final stable display brightness as the first display area AA1, ensuring synchronized brightness variations across the two display areas, uniform display, and smooth dynamic refresh.

With continued reference to FIG. 4, optionally, in the display panel of the embodiments of the present disclosure, multiple pixel units 100 are arranged in an array along a row direction and a column direction, and the total duration for writing the data signal Vdata to pixel circuits 10 in one row of the multiple pixel units 100 is H, where |T1−T2|=n×H, and n is a positive integer.

The total duration H for writing the data signal Vdata to pixel circuits 10 in one row of the multiple pixel units 100 is essentially the minimum precision for timing adjustment by the display panel drive chip. In other words, the drive chip may adjust the timing of the drive signal in multiples of H. Based on this, an absolute value of (T1−T2) in this embodiment is constrained to an integer multiple of H. Essentially, the drive chip is used to achieve differentiated settings of the overlap time between the active pulse phase of the threshold compensation control signal S2N and the active pulse phase of the gate reset control signal S1N in the first display area AA1 and the second display area AA2, increasing the options for differentiating overlap time. In this manner, a more refined solution is provided for improving the unsynchronized brightness variations and uneven display caused by refresh rate differences between display areas.

With continued reference to FIG. 8 and FIG. 9, optionally, in the pixel circuit 10 of the first display area AA1, a first active pulse phase pulse1 is the active pulse phase of the gate reset control signal S1N, and a second active pulse phase pulse2 is the active pulse phase of the threshold compensation control signal S2N; in the pixel circuit 10 of the second display area AA2, a third active pulse phase pulse3 is the active pulse phase of the gate reset control signal S1N is a third active pulse phase pulse3, and a fourth active pulse phase pulse4 is the active pulse phase of the threshold compensation control signal S2N. The duration of the first active pulse phase pulse1 is equal to the duration of the third active pulse phase pulse3, and the duration of the second active pulse phase pulse2 is less than the duration of the fourth active pulse phase pulse4.

This embodiment shows that by the adjustment of the duration of the active pulse of the threshold compensation control signal S2N in the first display area AA1 and/or the second display area AA2, the overlap of the active pulses of the gate reset control signal S1N and the threshold compensation control signal S2N in the first display area AA1, the overlap of the active pulses of the gate reset control signal S1N and the threshold compensation control signal S2N in the second display area AA2, and the difference in the overlap time of active pluses of these two control signals between the two display areas can be achieved.

With continued reference to FIG. 8 and FIG. 9, in a specific embodiment, the display driving process of the pixel circuit 10 includes multiple display frames. The relative position of the first active pulse phase pulse1 in a display frame to which the first active pulse phase pulse1 belongs is the same as the relative position of the third active pulse phase pulse3 in a display frame to which the third active pulse phase pulse3 belongs. The relative position of an end moment of the second active pulse phase pulse2 in a display frame to which the second active pulse phase pulse2 belongs is the same as the relative position of an end moment of the fourth active pulse phase pulse4 in a display frame to which the fourth active pulse phase pulse4 belongs. The relative position of a start moment of the second active pulse phase pulse2 in the display frame to which the second active pulse phase pulse2 belongs is after the relative position of a start moment of the fourth active pulse phase pulse4 in the display frame to which the fourth active pulse phase pulse4 belongs.

It should first be noted that the display driving process of the display panel is generally a row-by-row scanning driving process from top to bottom. Thus, as shown in the driving timing graphs in FIG. 8 and FIG. 9, the driving processes of the first display area AA1 and the second display area AA2 are not synchronized. That is, edge alignment of the pulses of corresponding drive signals of the pixel circuits does not indicate timing synchronization. The alignment of the display frames of the pixel circuits in the two display areas is only used to compare the similarities and differences in the relative positions of the pulses of corresponding drive signals in their respective display frames. Thus, as shown in FIG. 8 and FIG. 9, in the two display areas, the position of the first active pulse phase pulse1 in a display frame to which the first active pulse phase pulse1 belongs can be understood as the same as the position of the third active pulse phase pulse3 in a display frame to which the third active pulse phase pulse3 belongs, and the relative position of the end moment, that is, the falling edge, of the second active pulse phase pulse2 in a display frame to which the second active pulse phase pulse2 belongs is the same as the relative position of the end moment, that is, the falling edge, of the fourth active pulse phase pulse4 in a display frame to which the fourth active pulse phase pulse4 belongs, while the relative position of the start moment, that is, the rising edge, of the second active pulse phase pulse2 in the display frame to which the second active pulse phase pulse2 belongs is after the relative position of the start moment, that is, the rising edge, of the fourth active pulse phase pulse4 in the display frame to which the fourth active pulse phase pulse4 belongs. The embodiment shown in FIG. 8 can be understood as follows. The start moments of the second active phase pulse2 and the fourth active pulse phase pulse4 are advanced, and the start moment of the fourth active pulse phase pulse4 is advanced by a greater amount. In this manner, not only the overlap of the second active pulse phase pulse2 and the first active pulse phase pulse1 and the overlap of the fourth active pulse phase pulse4 and the third active pulse phase pulse3 are achieved, but also the overlap time T2 of the fourth active pulse phase pulse4 and the third active pulse phase pulse3 is greater than the overlap time T1 of the second active pulse phase pulse2 and the first active pulse phase pulse1. The embodiment shown in FIG. 9 can be understood as follows: The start moment of the fourth active pulse phase pulse4 is advanced so that the fourth active pulse phase pulse4 overlaps with the third active pulse phase pulse3, while since the start moment of the second active pulse phase pulse2 is not advanced, the second active pulse phase pulse2 does not overlap with the first active pulse phase pulse1.

FIG. 11 to FIG. 14 are another four driving timing graphs of pixel circuits in different display areas of the display panel shown in FIG. 4. With reference to FIG. 4, FIG. 5, and FIG. 11 to FIG. 14, optionally, in the pixel circuit 10 of the first display area AA1, the active pulse phase of the gate reset control signal S1N is a first active pulse phase pulse1, and the active pulse phase of the threshold compensation control signal S2N is a second active pulse phase pulse2; in the pixel circuit 10 of the second display area AA2, the active pulse phase of the gate reset control signal S1N is a third active pulse phase pulse3, and the active pulse phase of the threshold compensation control signal S2N is a fourth active pulse phase pulse4. The duration of the first active pulse phase pulse1 is equal to the duration of the third active pulse phase pulse3, and the duration of the second active pulse phase pulse2 is equal to the duration of the fourth active pulse phase pulse4.

This embodiment shows that by the adjustment of the timing position of the active pulse of the threshold compensation control signal S2N or the gate reset control signal S1N in the first display area AA1 and/or the second display area AA2, the overlap of the active pulses of the gate reset control signal S1N and the threshold compensation control signal S2N in the first display area AA1, the overlap of the active pulses of the gate reset control signal S1N and the threshold compensation control signal S2N in the second display area AA2, and the difference in the overlap time of active pluses of these two control signals between the two display areas can be achieved.

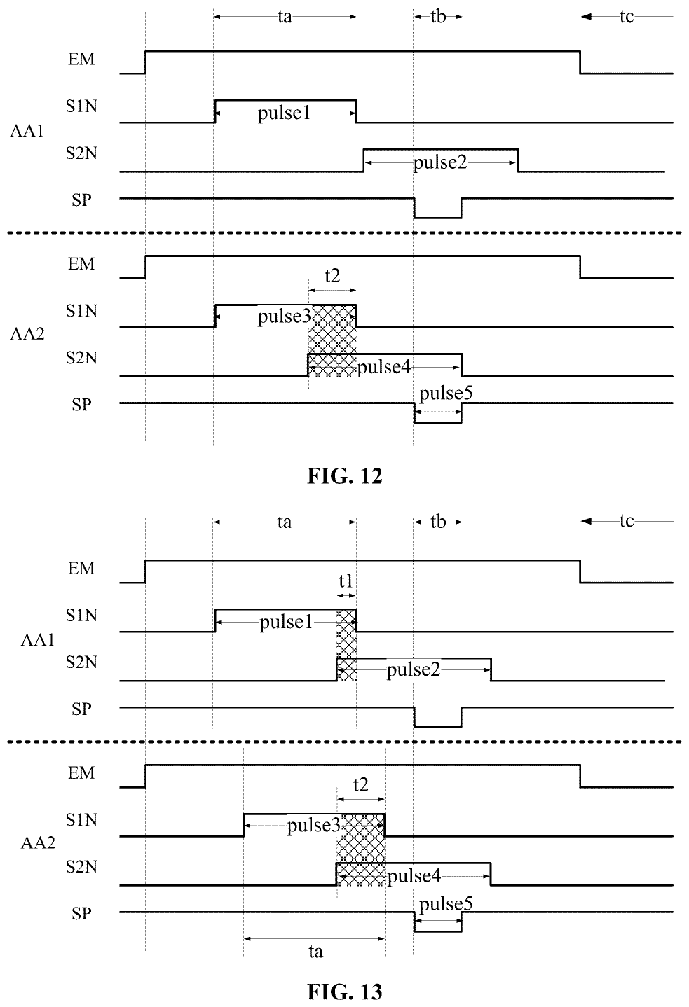

With continued reference to FIG. 11 and FIG. 12, in a specific embodiment, the display driving process of the pixel circuit 10 includes multiple display frames. The relative position of the first active pulse phase pulse1 in a display frame to which the first active pulse phase pulse1 belongs is the same as the relative position of the third active pulse phase pulse3 in a display frame to which the third active pulse phase pulse3 belongs. The relative position of the second active pulse phase pulse2 in a display frame to which the second active pulse phase pulse2 belongs is after the relative position of an end moment of the fourth active pulse phase pulse4 in a display frame to which the fourth active pulse phase pulse4 belongs.

Similarly, it can be understood that the driving processes of the first display area AA1 and the second display area AA2 are not synchronized. That is, edge alignment of the pulses of corresponding drive signals of the pixel circuits does not indicate timing synchronization. The alignment of the display frames of the pixel circuits in the two display areas is only used to compare the similarities and differences in the relative positions of the pulses of corresponding drive signals in their respective display frames. Thus, in the two display areas shown in FIG. 11 and FIG. 12, the position of the first active pulse phase pulse1 in a display frame to which the first active pulse phase pulse1 belongs can be understood as the same as the position of the third active pulse phase pulse3 in a display frame to which the third active pulse phase pulse3 belongs, and a difference exists in the relative position of the second active pulse phase pulse2 in a display frame to which the second active pulse phase pulse2 belongs and the relative position of the fourth active pulse phase pulse4 in a display frame to which the fourth active pulse phase pulse4 belongs. The second active pulse phase pulse2 is relatively later, and the fourth active pulse phase pulse4 is relatively earlier. The embodiment shown in FIG. 11 can be understood as follows: The second active pulse and the fourth active pulse phase pulse4 are advanced, and the start moment of the fourth active pulse phase pulse4 is advanced by a greater amount. In this manner, not only the overlap of the second active pulse phase pulse2 and the first active pulse phase pulse1 and the overlap of the fourth active pulse phase pulse4 and the third active pulse phase pulse3 are achieved, but also the overlap time T2 of the fourth active pulse phase pulse4 and the third active pulse phase pulse3 is greater than the overlap time T1 of the second active pulse phase pulse2 and the first active pulse phase pulse1. The embodiment shown in FIG. 12 can be understood as follows. The fourth active pulse phase pulse4 is advanced so that the fourth active pulse phase pulse4 overlaps with the third active pulse phase pulse3, while since the second active pulse phase pulse2 is not advanced, the second active pulse phase pulse2 does not overlap with the first active pulse phase pulse1.

With continued reference to FIG. 5 and FIG. 6, the pixel circuit 10 also includes a data write circuit 14, the drive transistor M3 also includes a second electrode, and the data write circuit 14 is coupled to the second electrode of the drive transistor M3. In an active pulse phase of the data write control signal SP, the data write circuit 14 of the pixel circuit 10 is also configured to write the data signal Vdata to the gate of the drive transistor M3 sequentially through the drive transistor M3 and the threshold compensation circuit 13.

The second electrode of the drive transistor M3 (that is, the second node N2) is coupled to the data write circuit 14, and during the active pulse phase of the data write control signal SP, the data write circuit 14 is turned on. In this case, the data signal Vdata is written to the gate of the drive transistor M3, that is, the first node N1, sequentially through the data write circuit 14, the second node N2, the drive transistor M3, the third node N3, and the threshold compensation circuit 13, thereby storing the data signal Vdata with threshold compensation to control the conduction current of the drive transistor M3 in the light emission phase tc and driving the light-emitting element 20 to emit light at the target brightness.

Based on this, with continued reference to FIG. 11 and FIG. 12, further, in the pixel circuit 10 of the second display area AA2, a fifth active pulse phase pulse5 is the active pulse phase of the data write control signal SP, and in the same display frame, the end moment of the fourth active pulse phase pulse4 is after the end moment of the fifth active pulse phase pulse5.

As mentioned earlier, the fourth active pulse phase pulse4 is advanced so that the fourth active pulse phase pulse4 can overlap with the third active pulse phase pulse3. The function of the fourth active pulse phase pulse4 is to ensure that the threshold compensation circuit 13 is turned on during the data write phase tb and that threshold compensation is performed on the data signal Vdata during data writing. Therefore, the fifth active pulse phase pulse5, that is, the data write phase tb, needs to fall within the fourth active pulse phase pulse4. Since in the general driving process of the pixel circuit, that is, in the driving timing where the fourth active pulse phase pulse4 is not advanced, the start moment of the fourth active pulse phase pulse4 is before the start moment of the fifth active pulse phase pulse5. Therefore, to ensure that the fifth active pulse phase pulse5, that is, the data write phase tb, falls within the fourth active pulse phase pulse4, when the fourth active pulse phase pulse4 is advanced, it is necessary to consider or satisfy that the end moment of the fourth active pulse phase pulse4 is after the end moment of the fifth active pulse phase pulse5. The solution in this embodiment can ensure that when the active pulse of the threshold compensation control signal S2N is adjusted, the data write phase tb is not affected, thus achieving normal driving and display.

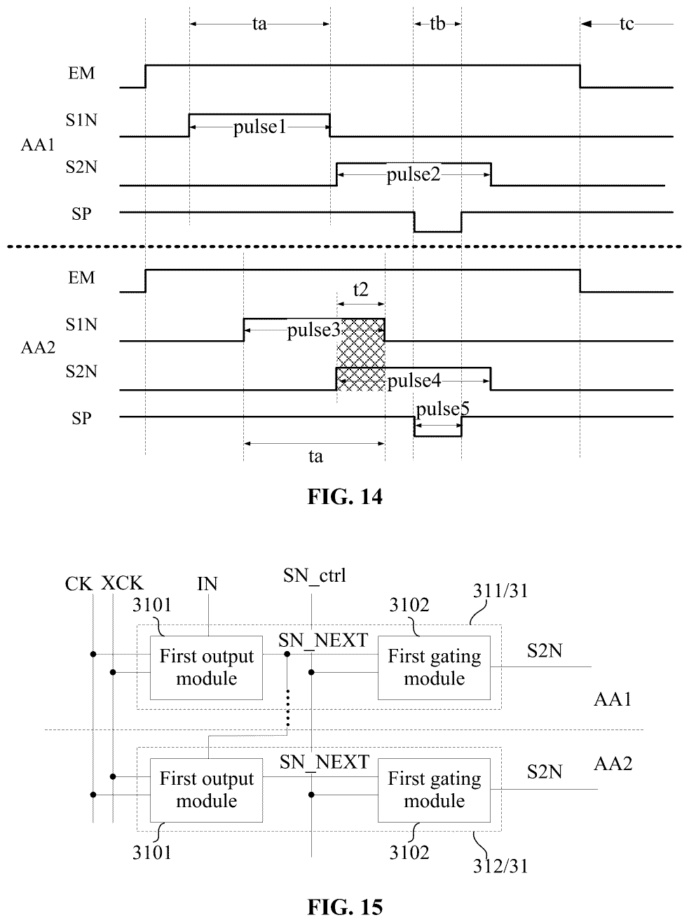

With continued reference to FIG. 13 and FIG. 14, in a specific embodiment, the display driving process of the pixel circuit 10 includes multiple display frames. The relative position of the first active pulse phase pulse1 in a display frame to which the first active pulse phase pulse1 belongs is before the relative position of the third active pulse phase pulse3 in a display frame to which the third active pulse phase pulse3 belongs. The relative position of the second active pulse phase pulse2 in a display frame to which the second active pulse phase pulse2 belongs is the same as the relative position of an end moment of the fourth active pulse phase pulse4 in a display frame to which the fourth active pulse phase pulse4 belongs.

Similarly, the alignment of the driving timing of the pixel circuits in the two display areas is only used to compare the similarities and differences in the relative positions of the pulses of corresponding drive signals in their respective display frames. Thus, in the two display areas shown in FIG. 13 and FIG. 14, the position of the second active pulse phase pulse2 in a display frame to which the second active pulse phase pulse2 belongs can be understood as the same as the position of the fourth active pulse phase pulse4 in a display frame to which the fourth active pulse phase pulse4 belongs, and a difference exists in the relative position of the first active pulse phase pulse1 in a display frame to which the first active pulse phase pulse1 belongs and the relative position of the third active pulse phase pulse3 in a display frame to which the third active pulse phase pulse3 belongs. The first active pulse phase pulse1 is relatively earlier, and the third active pulse phase pulse3 is relatively later. The embodiment shown in FIG. 13 can be understood as follows: The first active pulse and the third active pulse phase pulse3 are delayed, and the start moment of the third active pulse phase pulse3 is delayed by a greater amount. In this manner, not only the overlap of the first active pulse phase pulse1 and the second active pulse phase pulse2 and the overlap of the third active pulse phase pulse3 and the fourth active pulse phase pulse4 are achieved, but also the overlap time T2 of the third active pulse phase pulse3 and the fourth active pulse phase pulse4 is greater than the overlap time T1 of the first active pulse phase pulse1 and the second active pulse phase pulse2. The embodiment shown in FIG. 14 can be understood as follows: The third active pulse phase pulse3 is delayed so that the third active pulse phase pulse3 overlaps with the fourth active pulse phase pulse4, while since the first active pulse phase pulse1 is not delayed, the first active pulse phase pulse1 does not overlap with the second active pulse phase pulse2.

With continued reference to FIG. 11 and FIG. 12, further, in the pixel circuit 10 of the second display area AA2, the active pulse phase of the data write control signal SP is a fifth active pulse phase pulse5, and in the same display frame, the end moment of the third active pulse phase pulse3 is before the end moment of the fifth active pulse phase pulse5.

As mentioned earlier, the third active pulse phase pulse3 is delayed so that the third active pulse phase pulse3 can overlap with the fourth active pulse phase pulse4. The function of the third active pulse phase pulse3 is to turn on the gate reset circuit 12 in the gate reset phase ta, write the gate reset signal Vref1 to the gate of the drive transistor M3, and turn on the data write circuit 14 to write the data signal Vdata to the gate of the drive transistor M3. Based on this, in the process of delaying the third active pulse phase pulse3, the third active pulse phase pulse3 in this embodiment does not overlap with the fifth active pulse phase pulse5. That is, the end moment of the third active pulse phase pulse3 is before the start moment of the fifth active pulse phase. In this manner, it can be ensured that the gate reset phase does not overlap with the data write phase tb, thereby avoiding interference with the writing of the data signal Vdata and preventing impact on the brightness of the light-emitting element 20.

In the preceding embodiments, by the adjustment of the position and pulse width of the active pulses of the threshold compensation control signal S2N and/or the gate reset control signal S1N, the overlap of the two control signals and the differentiation of the overlap duration in different display areas can be achieved. For the preceding embodiments, the present disclosure also provides specific solutions for implementing and providing the threshold compensation control signal S2N and/or the gate reset control signal S1N.

With continued reference to FIG. 4, in the embodiments of the present disclosure, the display panel also includes multiple first shift register circuits 31 cascaded in sequence, and the first shift register circuit 31 is electrically connected to the threshold compensation circuit 13 for providing the threshold compensation control signal S2N to the threshold compensation circuit 13. The display panel also includes multiple second shift register circuits 32 cascaded in sequence, and the second shift register circuit 32 is electrically connected to the gate reset circuit 12 for providing the gate reset control signal S1N to the gate reset circuit 12. The multiple first shift register circuits 31 include a first sub-shift register circuit 311 and a second sub-shift register circuit 312. The first sub-shift register circuit 311 is electrically connected to a threshold compensation circuit 13 in the first display area AA1. The second sub-shift register circuit 312 is electrically connected to a threshold compensation circuit 13 in the second display area AA2. The multiple second shift register circuits 32 include a third sub-shift register circuit 323 and a fourth sub-shift register circuit 324. The third sub-shift register circuit 323 is electrically connected to a gate reset circuit 12 in the first display area AA1. The fourth sub-shift register circuit 324 is electrically connected to a gate reset circuit 12 in the second display area AA2.

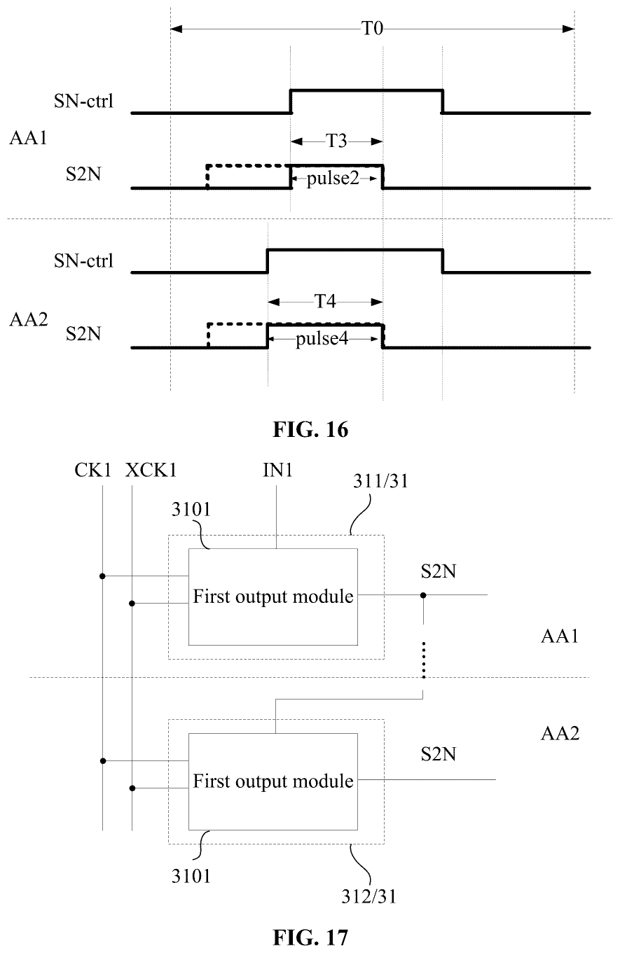

FIG. 15 is a schematic diagram illustrating the structure of a first shift register circuit 31 of the display panel shown in FIG. 4. FIG. 16 is another driving timing graph of the display panel shown in FIG. 4. With reference to FIG. 4, FIG. 15, and FIG. 16, for the embodiments shown in FIG. 8 and FIG. 9, the first shift register circuit 31 may include a first output circuit 3101 and a first gating circuit 3102. The first output circuit 3101 is configured to output a first output signal SN_NEXT. The first gating circuit 3102 at least receives the first output signal SN_NEXT and a first frequency control signal SN_CTRL and is configured to output the threshold compensation control signal S2N. When the first output signal SN_NEXT is an active pulse and the first frequency control signal SN_CTRL is an active pulse, the threshold compensation control signal S2N is an active pulse.

T3 denotes a duration in which both the first output signal SN_NEXT and the first frequency control signal SN_CTRL in the first sub-shift register circuit 311 are active pulses, and T4 denotes a duration in which both the first output signal SN_NEXT and the first frequency control signal SN_CTRL in the second sub-shift register circuit 312 are active pulses, where T3≠T4, T3>0, and T4>0.

The duration in which both the first output signal SN_NEXT and the first frequency control signal SN_CTRL are active pulses is the pulse width of the active pulse of the output threshold compensation control signal S2N. T3 and T4 both being greater than 0 indicates that the first sub-shift register circuit 311 and the second sub-shift register circuit 312 may respectively provide threshold compensation control signals S2N with a certain pulse width to the pixel circuits in the corresponding display areas to ensure the threshold compensation process of the pixel circuits.

Additionally, those skilled in the art can understand that for the driving of the pixel circuits of the display panel, current shift register circuits may be configured with an output circuit and a gating circuit. In the embodiments of the present disclosure, a first output circuit 3101 and a first gating circuit 3102 may be set. The first gating circuit 3102 is controlled by the first frequency control signal SN_CTRL to selectively output the active pulse of the first output signal SN_NEXT of the first output circuit 3101. Specifically, with reference to FIG. 15 and FIG. 16, the dashed pulse indicates the first output signal SN_NEXT output by the first output circuit 3101, and only when the first frequency control signal SN_CTRL is in an active pulse phase can the active pulse of the first output signal SN_NEXT be output to form the active pulse of the threshold compensation control signal S2N; otherwise, an inactive pulse is output. In short, the active pulse of the first frequency control signal SN_CTRL truncates the active pulse of the first output signal SN_NEXT that overlaps with the active pulse of the first frequency control signal SN_CTRL, thereby controlling the output and pulse width of the active pulse of the threshold compensation control signal S2N. In the embodiments of the present disclosure, on the basis that the active pulse of the first frequency control signal SN_CTRL can adjust the pulse width of the active pulse of the threshold compensation control signal S2N, the pulse timing of the first frequency control signal SN_CTRL output by the drive chip is controlled, as shown in FIG. 16, so that the time T3 during which both the first output signal SN_NEXT and the first frequency control signal SN_CTRL in the first sub-shift register circuit 311 are active pulses can be made different from the time T4 during which both the first output signal SN_NEXT and the first frequency control signal SN_CTRL in the second sub-shift register circuit 312 are active pulses. Specifically, when the refresh rate f1 of the first display area AA1 is greater than the refresh rate f2 of the second display area AA2, T3<T4 may be set. The essence of this solution is to advance the start moment of the active pulse corresponding to the second display area AA2 in the first frequency control signal SN_CTRL and increase the pulse width of the active pulse, thereby reducing the length of the active pulse of the first output signal SN_NEXT being truncated, that is, to increase the width of the active pulse of the output threshold compensation control signal S2N. For the embodiments shown in FIG. 8 and FIG. 9, this arrangement ensures that the active pulse of the threshold compensation control signal S2N in the second display area AA2 overlaps with the active pulse of the gate reset control signal S1N, that is, the fourth active pulse phase pulse4 overlaps with the third active pulse phase pulse3, and the overlap time T2 is greater than the overlap time T1 of the active pulse of the threshold compensation control signal S2N and the active pulse of the gate reset control signal S1N in the first display area AA1.

It should be understood that as shown in FIG. 16, the two first frequency control signals SN_CTRL are actually signals transmitted on the same signal line and represent the active pulses sent on the signal line at different times. The figure illustrates the relative positions of the active pulses on the signal line in the corresponding display frame T0, and the relative positions are used to reflect the differences in the active pulses provided by the first frequency control signal SN_CTRL for the first display area AA1 and the second display area AA2. It can be understood that the drive chip may provide first frequency control signals SN_CTRL with different pulse widths for the first display area AA1 and the second display area AA2, thereby achieving a differentiated solution for the overlap time between the active pulses of the threshold compensation control signal S2N and the gate reset control signal S1N in the first display area AA1 and the second display area AA2.

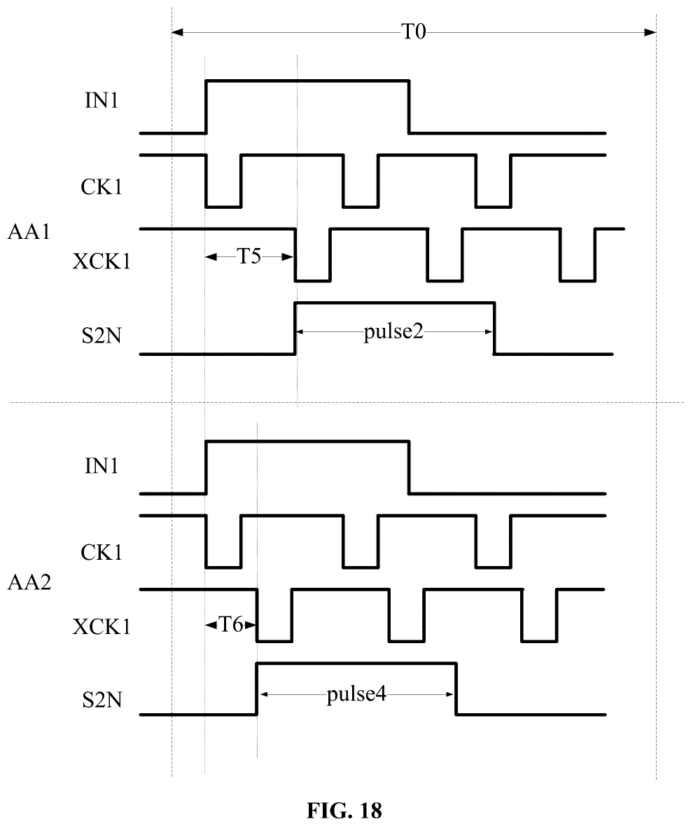

FIG. 17 is a schematic diagram illustrating the structure of another first shift register circuit 31 of the display panel shown in FIG. 4. FIG. 18 is another driving timing graph of the display panel shown in FIG. 4. With reference to FIG. 4, FIG. 17, and FIG. 18, for the embodiments shown in FIG. 11 and FIG. 12, the first shift register circuit 31 may include a first output circuit 3101, and the first output circuit 3101 at least receives a first input signal IN1, a first clock signal CK1, and a second clock signal XCK1 and is configured to output the threshold compensation control signal S2N. The active pulse of the second clock signal XCK1 is delayed relative to the active pulse of the first clock signal CK1. The active pulse of the threshold compensation control signal S2N is delayed relative to the active pulse of the first input signal IN1. The relative delay of the active pulse of the threshold compensation control signal S2N relative to the active pulse of the first input signal IN1 is equal to the relative delay of the active pulse of the second clock signal XCK1 relative to the active pulse of the first clock signal CK1.

In the first sub-shift register circuit 311, a first delay T5 is the relative delay of the active pulse of the second clock signal XCK1 relative to the active pulse of the first clock signal CK1, and in the second sub-shift register circuit 312, a second delay T6 is the relative delay of the active pulse of the second clock signal XCK1 relative to the active pulse of the first clock signal CK1, where T5≠T6, T5>0, and T6>0.

It should be noted that for the cascaded first shift register circuits 31, the first input signal IN1 of the latter of two adjacent shift register circuits is essentially the threshold compensation control signal S2N output by the former of two adjacent shift register circuits. Thus, through each stage of shift register circuit, the active pulse of the input first input signal IN1 can be shifted, providing threshold compensation control signals S2N with sequentially shifted active pulses to each row of pixel circuits in the display panel. Therefore, it can be understood that the delay of the active pulse of the second clock signal XCK1 relative to the active pulse of the first clock signal CK1 indicates that the shift register circuit achieves the shift of the input first input signal IN1, and it can also be understood that the relative delays of the first sub-shift register circuit 311 and the second sub-shift register circuit 312 cannot be zero.

Additionally, those skilled in the art can understand that for the driving of the pixel circuits of the display panel, current shift register circuits may be configured with an output circuit. In the embodiments of the present disclosure, a first output circuit 3101 may be provided. The first output circuit 3101 is controlled by the first input signal IN1, the first clock signal CK1, and the second clock signal XCK1 to delay the output of the active pulse of the first input signal IN1 to obtain a scanning signal of the pixel circuit. Specifically, with reference to FIG. 17 and FIG. 18, the first display area AA1 is used as an example. The function of the first output circuit 3101 includes: controlling the delayed output of the first input signal IN1 received at the input terminal based on the first clock signal CK1 and the second clock signal XCK1, and generating the threshold compensation control signal S2N. The active pulse of the second clock signal XCK1 is delayed relative to the active pulse of the first clock signal CK1, and the delay of the active pulse of the second clock signal XCK1 relative to the active pulse of the first clock signal CK1 determines the delay of the output threshold compensation control signal S2N relative to the first input signal IN1. The second display area AA2 is similar and not repeated here.

In the embodiments of the present disclosure, the active pulse of the second clock signal XCK1 is delayed relative to the active pulse of the first clock signal CK1, which can control the delay of the output threshold compensation control signal S2N. Based on that, the pulse timing of the first clock signal CK1 and the second clock signal XCK1 output by the drive chip is controlled, as shown in FIG. 18, so that the relative delay of the active pulse of the second clock signal XCK1 relative to the active pulse of the first clock signal CK1 in the first sub-shift register circuit 311 is different from the relative delay of the active pulse of the second clock signal XCK1 relative to the active pulse of the first clock signal CK1 in the second sub-shift register circuit 312, that is, T5≠T6. Thus, the threshold compensation control signal S2N in the first display area AA1 and the second display area AA2 can be adjusted to have different delays, achieving the effect of advancing or delaying the active pulse. Specifically, when the refresh rate f1 of the first display area AA1 is greater than the refresh rate f2 of the second display area AA2, T5>T6 is set. The essence of this solution is to advance the active pulse of the output threshold compensation control signal S2N in the second display area AA2. For the embodiments shown in FIG. 11 and FIG. 12, this arrangement ensures that the active pulse of the threshold compensation control signal S2N in the second display area AA2 overlaps with the active pulse of the gate reset control signal S1N, that is, the fourth active pulse phase pulse4 overlaps with the third active pulse phase pulse3, and the overlap time T2 is greater than the overlap time T1 of the active pulse of the threshold compensation control signal S2N and the active pulse of the gate reset control signal S1N in the first display area AA1.

It should be understood that as shown in FIG. 18, the first clock signal CK1 is actually a signal transmitted on the same signal line, and the second clock signal XCK1 is essentially a signal transmitted on the same signal line. The first clock signal CK1 and the second clock signal XCK1 represent the active pulses sent on the signal line at different times. The figure illustrates the relative positions of the active pulses on the signal line in the corresponding display frame T0, and the relative positions are used to reflect the differences in the active pulses provided by the first clock signal CK1 and the second clock signal XCK1 for the first display area AA1 and the second display area AA2. It can be understood that the drive chip may provide first clock signals CK1 and second clock signals XCK1 with different delays for the first display area AA1 and the second display area AA2, thereby achieving a differentiated solution for the overlap time between the active pulses of the threshold compensation control signal S2N and the gate reset control signal S1N in the first display area AA1 and the second display area AA2.

It should also be noted that in the shift register circuit shown in FIG. 17, a gating circuit may be added to selectively output the threshold compensation control signal S2N output by the first output circuit 3101 based on a frequency control signal, achieving a partitioned frequency division effect, which is not repeated here.

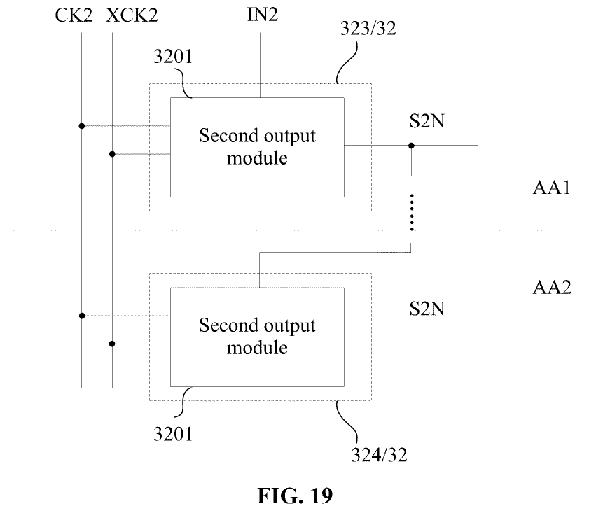

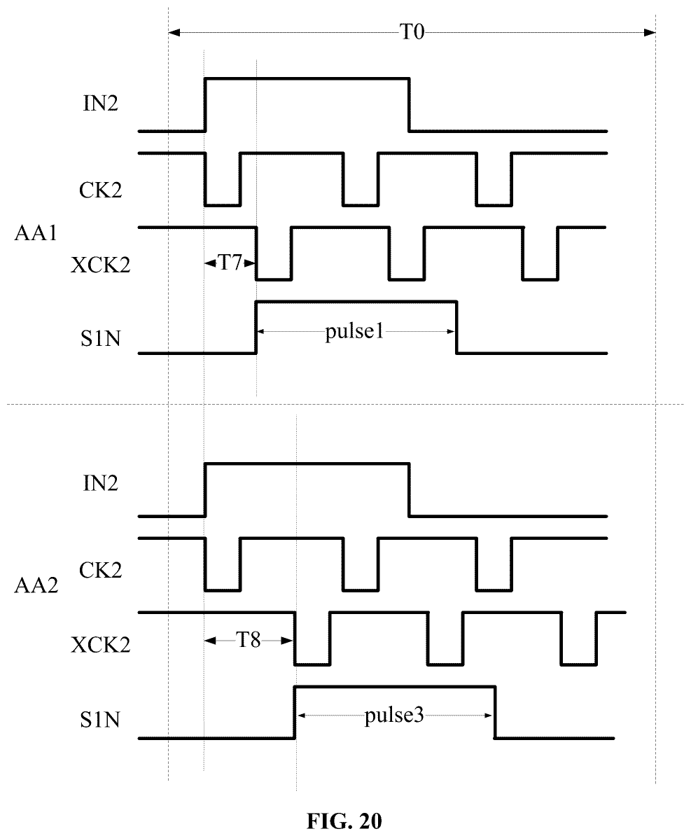

FIG. 19 is a schematic diagram illustrating the structure of another first shift register circuit 31 of the display panel shown in FIG. 4. FIG. 20 is another driving timing graph of the display panel shown in FIG. 4. With reference to FIG. 4, FIG. 19, and FIG. 20, for the embodiments shown in FIG. 13 and FIG. 14, the second shift register circuit 32 may include a second output circuit 3201, and the second output circuit 3201 at least receives a second input signal IN2, a third clock signal CK2, and a fourth clock signal XCK2 and is configured to output the gate reset control signal S1N. The active pulse of the fourth clock signal XCK2 is delayed relative to the active pulse of the third clock signal CK2. The active pulse of the gate reset control signal S1N is delayed relative to the active pulse of the second input signal IN2. The relative delay of the active pulse of the gate reset control signal S1N relative to the active pulse of the second input signal IN2 is equal to the relative delay of the active pulse of the fourth clock signal XCK2 relative to the active pulse of the third clock signal CK2.

In the third sub-shift register circuit 323, the relative delay of the active pulse of the fourth clock signal XCK2 relative to the active pulse of the third clock signal CK2 is a third delay T7, and in the fourth sub-shift register circuit 324, the relative delay of the active pulse of the fourth clock signal XCK2 relative to the active pulse of the third clock signal CK2 is a fourth delay T8, where T7≠T8, T7>0, and T8>0.

It should also be noted here that for the cascaded second shift register circuits 32, the second input signal IN2 of the latter of two adjacent shift register circuits is essentially the gate reset control signal S1N output by the former of two adjacent shift register circuits. Thus, through each stage of shift register circuit, the active pulse of the input second input signal IN2 can be shifted, providing gate reset control signals S1N with sequentially shifted active pulses to each row of pixel circuits in the display panel. Therefore, it can be understood that the delay of the active pulse of the third clock signal CK2 relative to the active pulse of the fourth clock signal XCK2 indicates that the shift register circuit achieves the shift of the input second input signal IN2, and it can also be understood that the relative delays of the third sub-shift register circuit 323 and the fourth sub-shift register circuit 324 cannot be zero.

In the embodiments of the present disclosure, the active pulse of the fourth clock signal XCK2 is delayed relative to the active pulse of the third clock signal CK2, which can control the delay of the output gate reset control signal S1N. Based on that, the pulse timing of the third clock signal CK2 and the fourth clock signal XCK2 output by the drive chip is controlled, as shown in FIG. 20, so that the relative delay of the active pulse of the fourth clock signal XCK2 relative to the active pulse of the third clock signal CK2 in the third sub-shift register circuit 323 can be made different from the relative delay of the active pulse of the fourth clock signal XCK2 relative to the active pulse of the third clock signal CK2 in the fourth sub-shift register circuit 324, that is, T7≠T8. Thus, the gate reset control signal S1N in the first display area AA1 and the second display area AA2 can be adjusted to have different delays, achieving the effect of advancing or delaying the active pulse. Specifically, when the refresh rate f1 of the first display area AA1 is greater than the refresh rate f2 of the second display area AA2, T7<T8 is set. The essence of this solution is to delay the active pulse of the gate reset control signal S1N in the second display area AA2. For the embodiments shown in FIG. 13 and FIG. 14, this arrangement ensures that the active pulse of the gate reset control signal S1N in the second display area AA2 overlaps with the active pulse of the threshold compensation control signal S2N, that is, the third active pulse phase pulse3 overlaps with the fourth active pulse phase pulse4, and the overlap time T2 is greater than the overlap time T1 of the active pulse of the gate reset control signal S1N and the active pulse of the threshold compensation control signal S2N in the first display area AA1.

It should be understood that as shown in FIG. 20, the third clock signal CK2 is actually a signal transmitted on the same signal line, and the fourth clock signal XCK2 is essentially a signal transmitted on the same signal line. The third clock signal CK2 and the fourth clock signal XCK2 represent the active pulses sent on the signal line at different times. The figure illustrates the relative positions of the active pulses on the signal line in the corresponding display frame T0, and the relative positions are used to reflect the differences in the active pulses provided by the third clock signal CK2 and the fourth clock signal XCK2 for the first display area AA1 and the second display area AA2. It can be understood that the drive chip may provide third clock signals CK2 and fourth clock signals XCK2 with different delays for the first display area AA1 and the second display area AA2, thereby achieving a differentiated solution for the overlap time between the active pulses of the threshold compensation control signal S2N and the gate reset control signal S1N in the first display area AA1 and the second display area AA2.

It should also be noted that in the shift register circuit shown in FIG. 19, a gating circuit may be added to selectively output the gate reset control signal S1N output by the second output circuit 3201 based on a frequency control signal, achieving a partitioned frequency division effect, which is not repeated here.

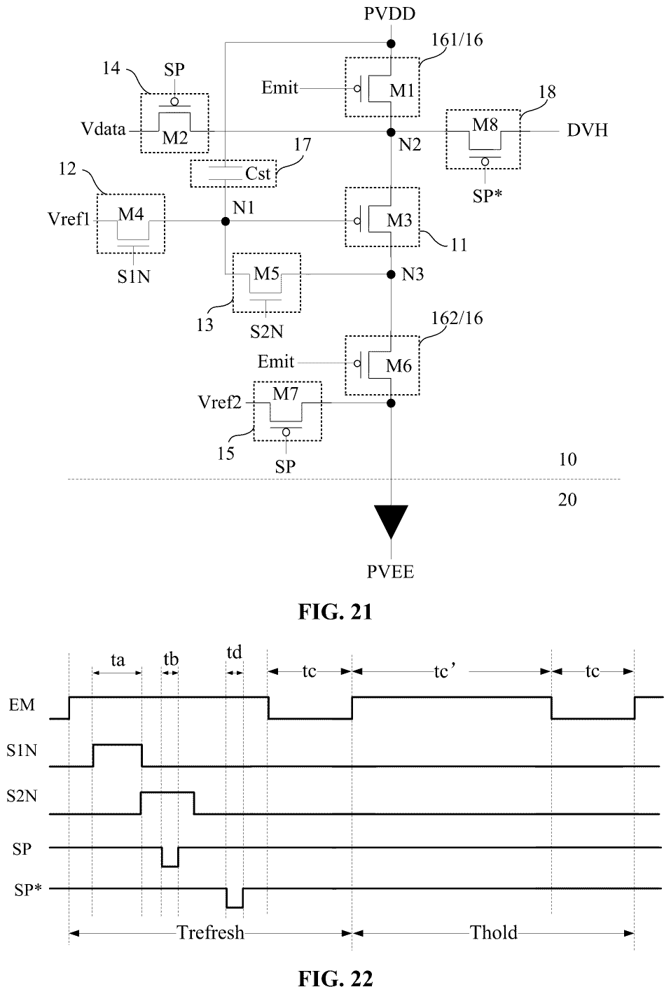

FIG. 21 is a schematic diagram illustrating the structure of another pixel circuit according to an embodiment of the present disclosure. FIG. 22 is a drive timing graph of the pixel circuit shown in FIG. 21. With reference to FIG. 21 and FIG. 22, based on the preceding embodiments, the pixel circuit 10 also includes a bias adjustment circuit 18, the drive transistor M3 also includes a second electrode, and the bias adjustment circuit 18 is coupled to the second electrode. The bias adjustment circuit 18 of the pixel circuit 10 is also configured to write a bias adjustment signal DVH to the second electrode of the drive transistor M3 in an active pulse phase of a bias adjustment control signal SP*. The active pulse phase of the bias adjustment control signal SP* does not overlap with the active pulse phase of the threshold compensation control signal S2N and the active pulse phase of the gate reset control signal S1N.

Specifically, the bias adjustment circuit 18 may include a bias adjustment transistor M8. The gate of the bias adjustment transistor M8 receives the bias adjustment control signal SP*. One end of the bias adjustment transistor M8 receives the bias adjustment signal DVH, and the other end is connected to the second electrode, that is, the second node N2, of the drive transistor M3. As shown in FIG. 22, the active pulse phase of the bias adjustment control signal SP* represents the bias adjustment phase td. In the bias adjustment phase td, the bias adjustment control signal SP* is at a logic low level and is an active pulse. In this case, the bias adjustment circuit 18 is turned on, and the bias adjustment signal DVH is written to the second electrode of the drive transistor M3. In this manner, the drive transistor M3 can be reversely biased, opposite to the forward bias state of the drive transistor M3 in phases such as the light emission phase tc. This arrangement can adjust the bias state of the drive transistor M3 to compensate for the drift in the electrical characteristics of the drive transistor M3 caused by prolonged forward bias, thereby reducing the brightness increase of the light-emitting element 20 due to the increased threshold voltage of the drive transistor M3 to some extent, reducing the final stable display brightness of each display area, narrowing the difference in the brightness ratio of the first frame display brightness to the final stable display brightness of each display area, and thus reducing the difference in the brightness ratio between different display areas.

It can be understood that the bias adjustment circuit 18 is used to adjust the potential of the second electrode of the drive transistor M3, while the gate reset circuit 12 is used for gate reset, and the threshold compensation circuit 13 is used for threshold compensation. Clearly, the functions of these two circuits are different from and interact with the function of the bias adjustment circuit 18. Therefore, when the active pulse phase of the bias adjustment control signal SP* is set, it is necessary to avoid the active pulse phases of the gate reset control signal S1N and the threshold compensation control signal S2N to ensure the normal function of the bias adjustment.

Further, the image refresh cycle T of the first display area AA1 includes one refresh frame Trefresh and m1 hold frames Thold, and the image refresh cycle T of the second display area AA2 includes one refresh frame Trefresh and m2 hold frames Thold, where m1 and m2 are each a positive integer, and 0≤m1<m2. In the pixel circuit 10 of the first display area AA1, the ratio of the brightness of the light-emitting element 20 in the refresh frame Trefresh to the maximum brightness of the light-emitting element 20 in the hold frame Thold is a first brightness ratio, and in the pixel circuit 10 of the second display area AA2, the ratio of the brightness of the light-emitting element 20 in the refresh frame Trefresh to the maximum brightness of the light-emitting element 20 in the hold frame Thold is a second brightness ratio, where the first brightness ratio and the second brightness ratio are both greater than or equal to 80%.

The brightness of the light-emitting element 20 in the refresh frame Trefresh represents the first frame display brightness of the image refresh cycle T, and the maximum brightness of the light-emitting element 20 in the hold frame Thold represents the final stable display brightness of the image refresh cycle T. Based on this, with reference to FIG. 10, in this embodiment, m1=1, and m2=2. That is, for the second display area AA2, the number of hold frames Thold in the same image refresh cycle T is relatively large, and the duration is longer. Thus, the degree of drift in the electrical characteristic curve of the drive transistor is greater, and the threshold voltage is larger, resulting in a higher final stable display brightness in the current image refresh cycle T. In other words, the brightness ratio of the first frame display brightness to the final stable display brightness in the second display area AA2 is relatively small compared to that in the first display area AA1. Accordingly, in the embodiments of the present disclosure, differentiated settings for the overlap time between the active pulse phase of the threshold compensation control signal S2N and the active pulse phase of the gate reset control signal S1N in the pixel circuits 10 of the first display area AA1 and the second display area AA2 can be performed, and the bias adjustment circuit 18 is set to adjust the bias of the drive transistor M3 so that the first frame display brightness of the two display areas can be enhanced to some extent, thereby adjusting the ratio of the first frame display brightness to the final stable display brightness. Further, in the embodiments of the present disclosure, the ratio of the first frame display brightness to the final stable display brightness in the first display area AA1 and the second display area AA2, that is, the first brightness ratio and the second brightness ratio, is controlled to be both greater than or equal to 80%. In this manner, it is possible to ensure a relatively small brightness difference between the first frame brightness and the final stable display brightness, thereby avoiding noticeable uneven display issues perceived by the human eye and improving the display effect of the display panel.

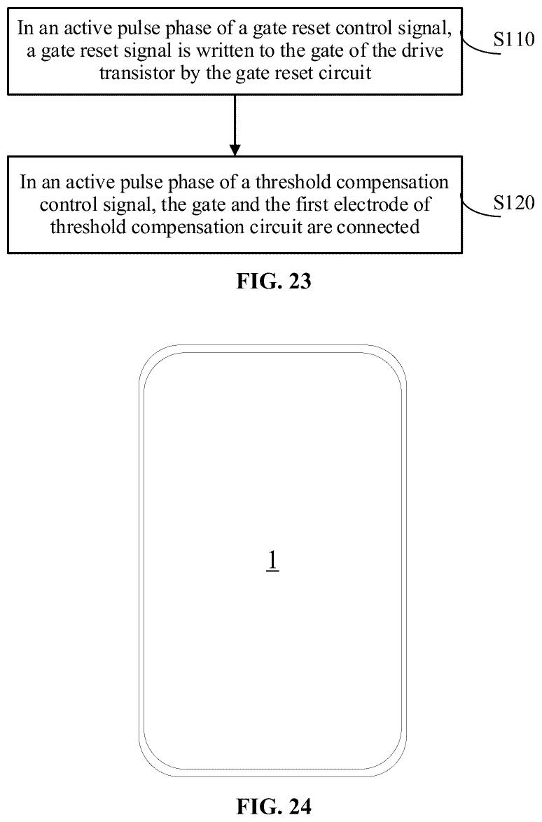

Based on the same inventive concept, the embodiments of the present disclosure also provide a driving method for a display panel. FIG. 23 is a flowchart of a driving method of a display panel according to an embodiment of the present disclosure. With reference to FIG. 23, the driving method includes S110 and S120.

In S110, in an active pulse phase of a gate reset control signal, a gate reset signal is written to the gate of the drive transistor by the gate reset circuit.

In S120, in an active pulse phase of a threshold compensation control signal, the gate and the first electrode of the threshold compensation circuit are connected.

The display panel includes a first display area and a second display area. The first display area and the second display area do not overlap. The f1 denotes the refresh rate of the first display area, and f2 denotes the refresh rate of the second display area, where f1≠f2.

In the first display area and/or the second display area, a pixel circuit satisfying the following exists: The active pulse phase of the threshold compensation control signal and the active pulse phase of the gate reset control signal at least partially overlap. In the pixel circuit of the first display area, T1 denotes the overlap time between the active pulse phase of the threshold compensation control signal and the active pulse phase of the gate reset control signal, and in the pixel circuit of the second display area, T2 denotes the overlap time between the active pulse phase of the threshold compensation control signal and the active pulse phase of the gate reset control signal, where T1≠T2. Further optionally, f1>f2, 0≤T1<T2.

In the driving method provided by the embodiments of the present disclosure, the active pulse phase of the threshold compensation control signal and the active pulse phase of the gate reset control signal are configured to overlap. In this manner, during the process of writing a gate reset signal to the gate of the drive transistor, the threshold compensation circuit can be turned on to synchronously write the gate reset signal to the first electrode, that is, a third node, of the drive transistor. The gate reset signal is written so that the potential of the third node can be negatively biased, increasing the voltage difference across the drive transistor and facilitating the writing of a data signal in a data write phase. Meanwhile, the reverse bias of the third node potential can adjust an anode potential of the light-emitting element to a reverse bias, which also facilitates the activation of the light-emitting element. As a result, the brightness of the light-emitting element can be enhanced to a certain extent. In addition, the overlap time T1 between the active pulse phase of the threshold compensation control signal and the active pulse phase of the gate reset control signal in the first display area is not equal to the overlap time T2 between the active pulse phase of the threshold compensation control signal and the active pulse phase of the gate reset control signal in the second display area. In this manner, it is possible to set different overlap times according to the difference in the brightness ratio of the first frame display brightness to the final stable display brightness caused by the refresh rates of the first display area and the second display area. Thus, when the gate reset signal is written to the first electrode of the respective drive transistors, respective reverse bias effects of corresponding potentials can be achieved, thereby enhancing the brightness of the light-emitting element in the refresh frame, improving the first frame display brightness, balancing the brightness ratio of the first frame brightness to the final stable display brightness across display areas, and ensuring synchronized brightness variations across display areas, uniform display brightness, and smooth dynamic refresh.

Similarly, based on the same inventive concept, the embodiments of the present disclosure also provide a display device. FIG. 24 is a schematic diagram illustrating the structure of a display device according to an embodiment of the present disclosure. With reference to FIG. 24, the display device includes the display panel 1 provided by any embodiment of the present disclosure. Thus, the display device provided by the embodiments of the present disclosure has the corresponding beneficial effects of the display panel provided by the embodiments of the present disclosure, which are not repeated here. Exemplarily, the display device may be an electronic device such as a mobile phone, a computer, a smart wearable device (for example, a smart watch), or an in-vehicle display device, which is not limited in the embodiments of the present disclosure.

It is to be noted that the above are only preferred embodiments of the present disclosure and the technical principles used therein. It is to be understood by those skilled in the art that the present disclosure is not limited to the embodiments described herein. For those skilled in the art, various apparent modifications, adaptations, combinations, and substitutions can be made without departing from the scope of the present disclosure. Therefore, while the present disclosure is described in detail via the preceding embodiments, the present disclosure is not limited to the preceding embodiments and may include more equivalent embodiments without departing from the concept of the present disclosure. The scope of the present disclosure is determined by the scope of the appended claims.

What is claimed is:

1. A display panel, comprising a plurality of pixel units, wherein a pixel unit of the plurality of pixel units comprises a pixel circuit and a light-emitting element;
the pixel circuit comprises a drive circuit, a gate reset circuit, and a threshold compensation circuit, the drive circuit comprises a drive transistor, the drive transistor comprises a gate and a first electrode, the gate reset circuit is coupled to the gate, the light-emitting element is coupled to the first electrode, and the threshold compensation circuit is separately coupled to the gate and the first electrode of the drive transistor;
during an active pulse phase of a gate reset control signal, the gate reset circuit of the pixel circuit is configured to write a gate reset signal to the gate of the drive transistor; and
during an active pulse phase of a threshold compensation control signal, the threshold compensation circuit of the pixel circuit is configured to connect the gate and the first electrode;
wherein the display panel at least comprises a first display area and a second display area, the first display area and the second display area do not overlap, f1 denotes a refresh rate of the first display area is f1, f2 denotes a refresh rate of the second display area is f2, and f1≠f2;
in the first display area and/or the second display area, a pixel circuit satisfying the following:
the active pulse phase of the threshold compensation control signal and the active pulse phase of the gate reset control signal being at least partially overlapped; and
in the pixel circuit of the first display area, T1 denotes an overlap time between the active pulse phase of the threshold compensation control signal and the active pulse phase of the gate reset control signal, and in the pixel circuit of the second display area, T2 denotes an overlap time between the active pulse phase of the threshold compensation control signal and the active pulse phase of the gate reset control signal, and T1≠T2.

2. The display panel according to claim 1, wherein f1>f2, and 0≤T1<T2.

3. The display panel according to claim 1, wherein |f1−f2|>Δf, and Δf is a preset frequency difference.

4. The display panel according to claim 1, wherein a display driving process of the display panel comprises a plurality of image refresh cycles, and an image refresh cycle of the plurality of image refresh cycles comprises at least one refresh frame; and
in an image refresh cycle of the first display area, P1 denotes a duration proportion of a refresh frame in the image refresh cycle, and in an image refresh cycle of the second display area, P2 denotes a duration proportion of a refresh frame in the image refresh cycle, P1>P2, and 0≤T1<T2.

5. The display panel according to claim 1, wherein
in the pixel circuit of the first display area, the active pulse phase of the gate reset control signal is a first active pulse phase, and the active pulse phase of the threshold compensation control signal is a second active pulse phase;
in the pixel circuit of the second display area, the active pulse phase of the gate reset control signal is a third active pulse phase, and the active pulse phase of the threshold compensation control signal is a fourth active pulse phase; and
a duration of the first active pulse phase is equal to a duration of the third active pulse phase, and a duration of the second active pulse phase is less than a duration of the fourth active pulse phase.

6. The display panel according to claim 5, wherein a display driving process of the pixel circuit comprises a plurality of display frames;
a relative position of the first active pulse phase in a display frame to which the first active pulse phase belongs is the same as a relative position of the third active pulse phase in a display frame to which the third active pulse phase belongs;
a relative position of an end moment of the second active pulse phase in a display frame to which the second active pulse phase belongs is the same as a relative position of an end moment of the fourth active pulse phase in a display frame to which the fourth active pulse phase belongs; and
a relative position of a start moment of the second active pulse phase in the display frame to which the second active pulse phase belongs is after a relative position of a start moment of the fourth active pulse phase in the display frame to which the fourth active pulse phase belongs.

7. The display panel according to claim 1, wherein
in the pixel circuit of the first display area, the active pulse phase of the gate reset control signal is a first active pulse phase, and the active pulse phase of the threshold compensation control signal is a second active pulse phase;
in the pixel circuit of the second display area, the active pulse phase of the gate reset control signal is a third active pulse phase, and the active pulse phase of the threshold compensation control signal is a fourth active pulse phase; and
a duration of the first active pulse phase is equal to a duration of the third active pulse phase, and a duration of the second active pulse phase is equal to a duration of the fourth active pulse phase.

8. The display panel according to claim 7, wherein a display driving process of the pixel circuit comprises a plurality of display frames;
a relative position of the first active pulse phase in a display frame to which the first active pulse phase belongs is the same as a relative position of the third active pulse phase in a display frame to which the third active pulse phase belongs; and
a relative position of the second active pulse phase in a display frame to which the second active pulse phase belongs is after a relative position of an end moment of the fourth active pulse phase in a display frame to which the fourth active pulse phase belongs.

9. The display panel according to claim 8, wherein the pixel circuit further comprises a data write circuit, the drive transistor further comprises a second electrode, and the data write circuit is coupled to the second electrode;
in an active pulse phase of a data write control signal, the data write circuit of the pixel circuit is configured to write a data signal to the gate of the drive transistor sequentially through the drive transistor and the threshold compensation circuit; and
in the pixel circuit of the second display area, the active pulse phase of the data write control signal is a fifth active pulse phase, and in a same display frame, an end moment of the fourth active pulse phase is after an end moment of the fifth active pulse phase.

10. The display panel according to claim 7, wherein a display driving process of the pixel circuit comprises a plurality of display frames;
a relative position of the first active pulse phase in a display frame to which the first active pulse phase belongs is before a relative position of the third active pulse phase in a display frame to which the third active pulse phase belongs; and
a relative position of the second active pulse phase in a display frame to which the second active pulse phase belongs is the same as a relative position of an end moment of the fourth active pulse phase in a display frame to which the fourth active pulse phase belongs.

11. The display panel according to claim 10, wherein the pixel circuit further comprises a data write circuit, the drive transistor further comprises a second electrode, and the data write circuit is coupled to the second electrode;
during an active pulse phase of a data write control signal, the data write circuit of the pixel circuit is configured to write a data signal to the second electrode of the drive transistor; and
in the pixel circuit of the second display area, the active pulse phase of the data write control signal is a fifth active pulse phase, and in a same display frame, an end moment of the third active pulse phase is before a start moment of the fifth active pulse phase.

12. The display panel according to claim 1, wherein the pixel circuit further comprises a data write circuit, the drive transistor further comprises a second electrode, and the data write circuit is coupled to the second electrode;
in an active pulse phase of a data write control signal, the data write circuit of the pixel circuit is configured to write a data signal to the second electrode of the drive transistor; and
the plurality of pixel units are arranged in an array along a row direction and a column direction, and a total duration for writing the data signal to pixel circuits in one row of the plurality of pixel units is H;
wherein |T1−T2|=n×H, and n is a positive integer.

13. The display panel according to claim 1, further comprising a plurality of first shift register circuits cascaded in sequence, wherein a first shift register circuit of the plurality of first shift register circuits is electrically connected to the threshold compensation circuit for providing the threshold compensation control signal to the threshold compensation circuit;
the first shift register circuit comprises a first output circuit and a first gating circuit;
the first output circuit is configured to output a first output signal, and the first gating circuit at least receives the first output signal and a first frequency control signal and is configured to output the threshold compensation control signal;
when the first output signal is an active pulse and the first frequency control signal is an active pulse, the threshold compensation control signal is an active pulse;
the plurality of first shift register circuits comprise a first sub-shift register circuit and a second sub-shift register circuit, the first sub-shift register circuit is electrically connected to a threshold compensation circuit in the first display area, and the second sub-shift register circuit is electrically connected to a threshold compensation circuit in the second display area; and
T3 denotes a duration in which both the first output signal and the first frequency control signal in the first sub-shift register circuit are active pulses, T4 denotes a duration in which both the first output signal and the first frequency control signal in the second sub-shift register circuit are active pulses;
wherein T3≠T4, T3>0, and T4>0;
wherein f1>f2, and T3<T4.

14. The display panel according to claim 1, further comprising a plurality of first shift register circuits cascaded in sequence, wherein a first shift register circuit of the plurality of first shift register circuits is electrically connected to the threshold compensation circuit for providing the threshold compensation control signal to the threshold compensation circuit;
the first shift register circuit comprises a first output circuit, and the first output circuit at least receives a first input signal, a first clock signal, and a second clock signal and is configured to output the threshold compensation control signal;
an active pulse of the second clock signal is delayed relative to an active pulse of the first clock signal, an active pulse of the threshold compensation control signal is delayed relative to an active pulse of the first input signal, and a relative delay of the active pulse of the threshold compensation control signal relative to the active pulse of the first input signal is equal to a relative delay of the active pulse of the second clock signal relative to the active pulse of the first clock signal;
the plurality of first shift register circuits comprise a first sub-shift register circuit and a second sub-shift register circuit, the first sub-shift register circuit is electrically connected to a threshold compensation circuit in the first display area, and the second sub-shift register circuit is electrically connected to a threshold compensation circuit in the second display area; and
a first delay T5 is a relative delay of the active pulse of the second clock signal relative to the active pulse of the first clock signal in the first sub-shift register circuit, and a second delay T6 is a relative delay of the active pulse of the second clock signal relative to the active pulse of the first clock signal in the second sub-shift register circuit;
wherein T5≠T6, T5>0, and T6>0;
wherein f1>f2, and T5>T6.

15. The display panel according to claim 1, further comprising a plurality of second shift register circuits cascaded in sequence, wherein a second shift register circuit of the plurality of second shift register circuits is electrically connected to the gate reset circuit for providing the gate reset control signal to the gate reset circuit;
the second shift register circuit comprises a second output circuit, and the second output circuit at least receives a second input signal, a third clock signal, and a fourth clock signal and is configured to output the gate reset control signal;
an active pulse of the fourth clock signal is delayed relative to an active pulse of the third clock signal, an active pulse of the gate reset control signal is delayed relative to an active pulse of the second input signal, and a relative delay of the active pulse of the gate reset control signal relative to the active pulse of the second input signal is equal to a relative delay of the active pulse of the fourth clock signal relative to the active pulse of the third clock signal;
the plurality of second shift register circuits comprise a third sub-shift register circuit and a fourth sub-shift register circuit, the third sub-shift register circuit is electrically connected to a gate reset circuit in the first display area, and the fourth sub-shift register circuit is electrically connected to a gate reset circuit in the second display area; and
a third delay T7 is a relative delay of the active pulse of the fourth clock signal relative to the active pulse of the third clock signal in the third sub-shift register circuit, and a fourth delay T8 is a relative delay of the active pulse of the fourth clock signal relative to the active pulse of the third clock signal in the fourth sub-shift register circuit;
wherein T7≠T8, T7>0, and T8>0;
wherein f1>f2, and T7<T8.

16. The display panel according to claim 1, wherein a display driving process of the display panel comprises a plurality of image refresh cycles;
an image refresh cycle of the first display area comprises one refresh frame and m1 hold frames, and the image refresh cycle of the second display area comprises one refresh frame and m2 hold frames; wherein m1 and m2 are each a positive integer, and 0≤m1<m2; and
in the pixel circuit of the first display area, a first brightness ratio is a ratio of a brightness of the light-emitting element in the refresh frame to a maximum brightness of the light-emitting element in the hold frames, and in the pixel circuit of the second display area, a ratio of a brightness of the light-emitting element in the refresh frame to a maximum brightness of the light-emitting element in the hold frames is a second brightness ratio;
wherein the first brightness ratio and the second brightness ratio are both greater than or equal to 80%.

17. The display panel according to claim 1, wherein the pixel circuit further comprises a bias adjustment circuit, the drive transistor further comprises a second electrode, and the bias adjustment circuit is coupled to the second electrode;
the pixel circuit is further configured to:
during an active pulse phase of a bias adjustment control signal, cause the bias adjustment circuit to write a bias adjustment signal to the second electrode of the drive transistor; and
the active pulse phase of the bias adjustment control signal does not overlap with the active pulse phase of the threshold compensation control signal or the active pulse phase of the gate reset control signal.

18. A driving method for a display panel, wherein the display panel comprises a plurality of pixel units, and a pixel unit of the plurality of pixel units comprises a pixel circuit and a light-emitting element;
the pixel circuit comprises a drive circuit, a gate reset circuit, and a threshold compensation circuit, the drive circuit comprises a drive transistor, the drive transistor comprises a gate and a first electrode, the gate reset circuit is coupled to the gate, the light-emitting element is coupled to the first electrode, and the threshold compensation circuit is separately coupled to the gate and the first electrode of the drive transistor; and the driving method comprises:
during an active pulse phase of a gate reset control signal, writing, by the gate reset circuit, a gate reset signal to the gate of the drive transistor; and
during an active pulse phase of a threshold compensation control signal, connecting the gate and the first electrode of the threshold compensation circuit;
wherein the display panel comprises a first display area and a second display area, the first display area and the second display area do not overlap, a refresh rate of the first display area is f1, and a refresh rate of the second display area is f2, where f1≠f2;
in the first display area and/or the second display area, a pixel circuit satisfying the following exists: the active pulse phase of the threshold compensation control signal and the active pulse phase of the gate reset control signal at least partially overlap; and
in the pixel circuit of the first display area, T1 denotes an overlap time between the active pulse phase of the threshold compensation control signal and the active pulse phase of the gate reset control signal, and in the pixel circuit of the second display area, T2 denotes an overlap time between the active pulse phase of the threshold compensation control signal and the active pulse phase of the gate reset control signal;
wherein T1≠T2.

19. The driving method according to claim 18, wherein f1>f2, and 0≤T1<T2.

20. A display device, comprising a display panel, wherein the display panel comprises:
a plurality of pixel units, wherein a pixel unit of the plurality of pixel units comprises a pixel circuit and a light-emitting element;
the pixel circuit comprises a drive circuit, a gate reset circuit, and a threshold compensation circuit, the drive circuit comprises a drive transistor, the drive transistor comprises a gate and a first electrode, the gate reset circuit is coupled to the gate, the light-emitting element is coupled to the first electrode, and the threshold compensation circuit is separately coupled to the gate and the first electrode of the drive transistor;
during an active pulse phase of a gate reset control signal, the gate reset circuit of the pixel circuit is configured to write a gate reset signal to the gate of the drive transistor; and
during an active pulse phase of a threshold compensation control signal, the threshold compensation circuit of the pixel circuit is configured to connect the gate and the first electrode;
wherein the display panel at least comprises a first display area and a second display area, the first display area and the second display area do not overlap, f1 denotes a refresh rate of the first display area is f1, f2 denotes a refresh rate of the second display area is f2, and f1≠f2;
in the first display area and/or the second display area, a pixel circuit satisfying the following:
the active pulse phase of the threshold compensation control signal and the active pulse phase of the gate reset control signal being at least partially overlapped; and
in the pixel circuit of the first display area, T1 denotes an overlap time between the active pulse phase of the threshold compensation control signal and the active pulse phase of the gate reset control signal, and in the pixel circuit of the second display area, T2 denotes an overlap time between the active pulse phase of the threshold compensation control signal and the active pulse phase of the gate reset control signal, and T1≠T2.
